(19) United States
(12) Patent Application Publication
(10) Pub. No.: US 2010/0279109 A1
(43) Pub. Date: Nov. 4, 2010

(54) LAMINATED FILM AND PROCESS FOR PRODUCING SEMICONDUCTOR DEVICE

(75) Inventors: Hironao OOTAKE, Osaka (JP); Katsuhiko KAMIYA, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Osaka (JP)

(21) Appl. No.: 12/763,585

(22) Filed: Apr. 20, 2010

(30) Foreign Application Priority Data
Apr. 30, 2009 (JP) 2009-110575

(51) Int. Cl. B32B 7/12; B32B 38/10

(52) U.S. Cl. 428/339; 428/343; 428/355 AC; 156/249

(57) ABSTRACT

The present invention provides a laminated film which includes a pressure-sensitive adhesive sheet including a pressure-sensitive adhesive layer, and a die-adhering layer laminated on the pressure-sensitive adhesive layer of the pressure-sensitive adhesive sheet, in which the pressure-sensitive adhesive layer of the pressure-sensitive adhesive sheet is formed of a pressure-sensitive adhesive composition containing a base polymer and a thermal crosslinking agent, and the pressure-sensitive adhesive layer is such that the gel fraction thereof before heating is less than 90% by weight and the gel fraction thereof after heating is changed to 90% by weight or more.

### FIELD OF THE INVENTION

The present invention relates to a laminated film and a process for producing a semiconductor device. More specifically, it relates to a laminated film as a pressure-sensitive adhesive sheet fitted with a die-adhering layer for use in the production of a semiconductor device and a process for producing a semiconductor device using the laminated film.

### BACKGROUND OF THE INVENTION

Hitherto, a semiconductor wafer (sometimes simply referred to as “wafer”) composed of silicon or gallium arsenide is mounted on a carrier such as a lead frame or a module substrate after a large wafer is cut into a small wafer (die). At the mounting, the wafer is adhered through an adhesive such as an epoxy resin. However, with the recent progress of miniaturization and thinning of the wafer, it becomes difficult to apply an appropriate amount of the adhesive to the small wafer without damaging the wafer.

With respect to the above-described problem, although there is a method of mounting a semiconductor chip after attaching a sheet-shaped die-adhering adhesive layer to a carrier in advance, an increase in step number and facility is indispensable since it is necessary to cut the die-adhering adhesive layer into the same size as the size of the semiconductor chip in advance.

Furthermore, there have been proposed various wafer-adhering pressure-sensitive adhesive sheets simultaneously having a fixing function at wafer cutting and a die-adhering function. That is, a semiconductor chip fitted with a die-adhering layer can be obtained by providing a die-adhering layer on a pressure-sensitive adhesive layer (wafer-fixing pressure-sensitive adhesive layer) of a dicing tape that is a wafer-fixing pressure-sensitive sheet, placing a semiconductor wafer thereon, cutting the wafer into small pieces, and subsequently picking up semiconductor chips through peeling them between the pressure-sensitive adhesive layer and the die-adhering layer.

In the above-described method, so-called direct bonding is enabled and production efficiency of the semiconductor chip can be improved to a large extent but there are required such conflicting functions that a wafer should be fixed so as not to generate chip fly in a cutting step and the chip should be easily peeled off between the pressure-sensitive adhesive layer and the die-adhering layer so as not to induce picking-up failure in a picking-up step.

With respect to the problem, there have been proposed various pressure-sensitive adhesive sheets having a mechanism of changing pressure-sensitive adhesive force between the wafer-fixing pressure-sensitive adhesive layer and the die-adhering layer by heat, radiation ray irradiation, or the like.

For example, there is disclosed a film wherein a dicing tape having a pressure-sensitive adhesive layer where a radiation ray-curable additive is added to a usual pressure-sensitive adhesive is laminated with a die-adhering layer in an integrated fashion (see, e.g., Patent Document 1). In the case where this laminated film is used, after diced, the wafer is irradiated with a radiation ray to cure the pressure-sensitive adhesive of the dicing tape and lower the pressure-sensitive adhesiveness and then a semiconductor chip can be peeled off at the interface between the die-adhering layer and the dicing tape in a perpendicular direction and thus the wafer fitted with the die-adhering layer can be picked up. However, since the method of using ultraviolet ray-curable pressure-sensitive adhesive layer as a pressure-sensitive adhesive layer is a method where radicals are generated in the pressure-sensitive adhesive layer, it is considered that a chemical reaction between a component in the die-adhering layer and a component in the pressure-sensitive adhesive layer may be induced by the generated radicals to deteriorate peeling ability or to degrade the die-adhering layer or the pressure-sensitive adhesive layer. Furthermore, since the pressure-sensitive adhesive layer is a radiation ray-curable pressure-sensitive adhesive layer, it is necessary to store the laminated film so as not to be exposed to a radiation ray such as an ultraviolet ray (UV) and thus there is a problem that the product management becomes complex.

Moreover, there is proposed a method of imparting heat without using any radiation ray (see, e.g., Patent Documents 2 and 3). For example, although there is a method of laminating a die-adhering layer on a pressure-sensitive adhesive layer containing heat-expandable microspheres of a heat-peelable pressure-sensitive adhesive sheet, there is a case where fouling occurs on the peeled surface of the die-adhering layer through cohesive failure of the pressure-sensitive adhesive component of the heat-peelable pressure-sensitive adhesive sheet. The fouling of the die-adhering layer may cause insufficient adhesion to the lead frame, module substrate, or the like or generation of voids at the interface between the die-adhering layer and the lead frame, module substrate, or the like during a reflow step after the semiconductor chip is mounted.

Furthermore, there is proposed a method of dispersing a gas-generating agent, which generates a gas by an external stimulus such as heat or an ultraviolet ray, into the pressure-sensitive adhesive layer of a pressure-sensitive adhesive sheet (see, e.g., Patent Document 3). However, in this method, peeling is possible while the gas is generated but when the gas generation has been completed and ceased, there is a problem that the die-adhering layer and the pressure-sensitive adhesive layer are re-adhered. Therefore, it is necessary to perform pick-up with imparting an external stimulus such as heat or ultraviolet ray irradiation, and thus a dedicated apparatus capable of the pick-up with imparting the external stimulus becomes necessary.

Patent Document 1: JP-A-02-248064

Patent Document 2: JP-A-03-268345

Patent Document 3: JP-A-2004-186280

### SUMMARY OF THE INVENTION

Accordingly, an object of the invention is to provide, as a laminated film having a constitution that a die-adhering layer and a pressure-sensitive adhesive sheet are laminated, a laminated film whose pressure-sensitive adhesive force between the pressure-sensitive adhesive layer and the die-adhering layer is changed by heat, wherein, in a processing step of a semiconductor wafer, “a semiconductor wafer can be effectively fixed and held in a dicing step of a semiconductor wafer”, “the die-adhering layer and the pressure-sensitive adhesive sheet can be easily peeled off in a picking-up step”, “fouling of the pressure-sensitive adhesive to the die-adhering layer can be reduced”, and further “storage stability is excellent”, as well as a process for producing a semiconductor device using the laminated film.

As a result of extensive studies in order to solve the above-described problems, the inventors of the present application have found that, when a pressure-sensitive adhesive layer containing a thermal crosslinking agent and having gel fractions before and after heating each controlled to a prescribed value is used as the pressure-sensitive adhesive layer in the pressure-sensitive adhesive sheet, a semiconductor wafer can be effectively fixed and held in the dicing step, the die-adhering layer and the pressure-sensitive adhesive sheet can be easily peeled off in the picking-up step after the dicing step, fouling of the pressure-sensitive adhesive to the die-adhering layer can be reduced, and further storage stability of the laminated film is excellent. Thus, the inventors have accomplished the invention.

Namely, the present invention provides a laminated film which includes a pressure-sensitive adhesive sheet including a pressure-sensitive adhesive layer, and a die-adhering layer laminated on the pressure-sensitive adhesive layer of the pressure-sensitive adhesive sheet, in which the pressure-sensitive adhesive layer of the pressure-sensitive adhesive sheet is formed of a pressure-sensitive adhesive composition containing a base polymer and a thermal crosslinking agent, and the pressure-sensitive adhesive layer is such that the gel fraction thereof before heating is less than 90% by weight and the gel fraction thereof after heating is changed to 90% by weight or more.

As above, since the laminated film of the invention (sometimes referred to as a “pressure-sensitive adhesive sheet fitted with (the) die-adhering layer”) has a constitution that a die-adhering layer is laminated on a pressure-sensitive adhesive layer of a pressure-sensitive adhesive sheet and has constitutions or characteristics of the following (1) and (2), a sufficient pressure-sensitive adhesive force between the pressure-sensitive adhesive layer and the die-adhering layer can be exhibited before heating, the pressure-sensitive adhesive force between the die-adhering layer and the pressure-sensitive adhesive layer of the pressure-sensitive adhesive sheet can be sufficiently lowered through curing the pressure-sensitive adhesive layer of the pressure-sensitive adhesive sheet after heating, and a low fouling property and storage stability can be exhibited.

(1) The pressure-sensitive adhesive layer of the pressure-sensitive adhesive sheet is a pressure-sensitive adhesive layer formed of a pressure-sensitive adhesive composition containing a base polymer and a thermal crosslinking agent.

(2) The pressure-sensitive adhesive layer is such that a gel fraction before heating is less than 90% by weight and a gel fraction after heating is changed to 90% by weight or more.

Specifically, since the pressure-sensitive adhesive sheet fitted with die-adhering layer according to the invention possesses a pressure-sensitive adhesive layer having the above-described constitutions or characteristics (sometimes referred to as a “gel-fraction highly changing pressure-sensitive adhesive layer”), in the cut-processing step (dicing step) of the semiconductor wafer, the gel fraction of the pressure-sensitive adhesive layer (gel-fraction highly changing pressure-sensitive adhesive layer) of the pressure-sensitive adhesive sheet is less than 90% by weight, an appropriate pressure-sensitive adhesive force can be exhibited, and a semiconductor wafer can be effectively fixed and held, whereby an effective dicing can be performed.

Moreover, in the picking-up step after the dicing step, since close adhesion between the gel-fraction highly changing pressure-sensitive adhesive layer and the die-adhering layer is lowered by changing the gel fraction of the pressure-sensitive adhesive layer (gel-fraction highly changing pressure-sensitive adhesive layer) of the pressure-sensitive adhesive sheet to 90% by weight or more by heating to lower the pressure-sensitive adhesive force of the gel-fraction highly changing pressure-sensitive adhesive layer, peeling can be easily achieved at the interface between the gel-fraction highly changing pressure-sensitive adhesive layer and the die-adhering layer. Therefore, a semiconductor chip fitted with the die-adhering layer where the die-adhering layer is adhered to the cut semiconductor chip can be easily picked up and thus it is possible to obtain the semiconductor chip fitted with the die-adhering layer effectively.

Furthermore, since the gel fraction of the pressure-sensitive adhesive layer of the pressure-sensitive adhesive sheet is enhanced to 90% by weight or more, the die-adhering layer can be peeled from the pressure-sensitive adhesive layer without generating cohesive failure of the pressure-sensitive adhesive component of the pressure-sensitive adhesive layer and it is possible to effectively suppress or prevent the fouling of the die-adhering layer due to a remaining of the pressure-sensitive adhesive component at peeling. Namely, in the picking-up step, the semiconductor chip fitted with the die-adhering layer can be picked up with reducing the fouling of the die-adhering layer with the pressure-sensitive adhesive and, after the picking-up step, the semiconductor chip fitted with the die-adhering layer with reduced fouling with the pressure-sensitive adhesive can be obtained.

Additionally, since the pressure-sensitive adhesive layer (gel-fraction highly changing pressure-sensitive adhesive layer) of the pressure-sensitive adhesive sheet has such a characteristic that the gel fraction is changed to 90% by weight or more by heating, the change of the gel fraction at ordinary temperature is suppressed or prevented. Therefore, the laminated film is excellent in storage stability and thus a stable storage state can be kept for a long period of time.

In the invention, as the thermal crosslinking agent contained in the pressure-sensitive adhesive composition for forming the gel-fraction highly changing pressure-sensitive adhesive layer, there is suitably used a thermal crosslinking agent where crosslinking-reactive functional groups are inactivated before heating and at least two crosslinking-reactive functional groups in one molecule are capable of being activated by heating. By controlling the crosslinking reaction before and after heating, the pressure-sensitive adhesive force between the die-adhering layer and the pressure-sensitive adhesive layer of the pressure-sensitive adhesive sheet can be easily controlled and thus it becomes possible to dramatically change the pressure-sensitive adhesive force before and after heating. Namely, it is possible to satisfy such required characteristics in the semiconductor production process that a high pressure-sensitive adhesive force is exhibited at the cutting of the semiconductor wafer and the pressure-sensitive adhesive force is sufficiently lowered at the picking-up of the cut semiconductor wafer. As the thermal crosslinking agent which satisfies such requirements, a blocked isocyanate is preferred.

In the invention, it is preferable that the base polymer contained in the pressure-sensitive adhesive composition for forming the pressure-sensitive adhesive layer of the pressure-sensitive adhesive sheet is an acrylic polymer composed of an acrylic acid alkyl ester represented by CH₂═CHCOOR (where R is an alkyl group having 6 to 10 carbon atoms) as a main monomer component, and the ratio of the acrylic acid alkyl ester represented by the above formula is 50 to 99% by mol based on the total amount of monomer components.

In the pressure-sensitive adhesive sheet fitted with die-adhering layer according to the invention, it is preferable that the pressure-sensitive adhesive layer has a pressure-sensitive adhesive force (peeling angle: 15°, drawing rate: 300 mm/min) at 23° C. of 1 N/10 mm width to 10 N/10 mm width when the laminated film is press-bonded (pressure: 1.47×10⁵ Pa, time: 1 minute) to a semiconductor wafer having a thickness of 0.6 mm by a heat lamination method at 40° C. in such a form that the die-adhering layer comes into contact with a surface of the semiconductor wafer and subsequently allowed to stand under an atmosphere of 23° C. for 30 minutes, and the pressure-sensitive adhesive layer has a pressure-sensitive adhesive force (peeling angle: 15°, drawing rate: 300 mm/min) at 23° C. of 5 N/10 mm width or less when the laminated film is press-bonded (pressure: 1.47×10⁵ Pa, time: 1 minute) to a semiconductor wafer having a thickness of 0.6 mm by a heat lamination method at 40° C. in such a form that the die-adhering layer comes into contact with a surface of the semiconductor wafer, subsequently allowed to stand under an atmosphere of 120° C. for 3 minutes, and thereafter allowed to stand under an atmosphere of 23° C. for 30 minutes.

The present invention also provides a process for producing a semiconductor device, in which a laminated film which includes a pressure-sensitive adhesive sheet including a pressure-sensitive adhesive layer, and a die-adhering layer laminated on the pressure-sensitive adhesive layer of the pressure-sensitive adhesive sheet is used, the process includes steps of:

attaching a semiconductor wafer to the die-adhering layer of the above-mentioned laminated film,

subjecting the semiconductor wafer having the laminated film attached thereto to a cut-processing treatment,

peeling semiconductor chips formed by the cut-processing treatment from the pressure-sensitive adhesive layer together with the die-adhering layer, and

adhering the semiconductor chip fitted with the die-adhering layer to an adherend.

According to the laminated film of the invention, in the cut-processing step of a semiconductor wafer, the semiconductor wafer can be effectively fixed and held in a dicing step of the semiconductor wafer, it is possible to easily peel the die-adhering layer from the pressure-sensitive adhesive sheet in a picking-up step, the fouling of the die-adhering layer with the pressure-sensitive adhesive can be reduced after the picking-up step, and also storage stability is excellent. Therefore, when the laminated film of the invention is used, the semiconductor wafer can be effectively fixed and held and dicing can be effectively performed in the dicing step at the production of a semiconductor, the fouling of an adherend surface can be suppressed or prevented and peeling can be easily performed by heating in the picking-up step, and a semiconductor chip fitted with the die-adhering layer where the fouling of the die-adhering layer is suppressed or prevented can be effectively obtained after the picking-up. Furthermore, the laminated film can suppress or prevent gel change of the pressure-sensitive adhesive layer during the storage at ordinary temperature and thus is excellent in storage stability. Therefore, when the laminated film of the invention is used, it becomes possible to produce a semiconductor device such as a semiconductor chip with an excellent productivity.

### BRIEF DESCRIPTION OF THE DRAWING

FIG. 1 is a cross-sectional schematic view showing one example of the laminated film of the invention.

### DESCRIPTION OF REFERENCE NUMERALS AND SIGNS

1 laminated film (pressure-sensitive adhesive sheet fitted with die-adhering layer)

2 pressure-sensitive adhesive sheet

2a base material

2b pressure-sensitive adhesive layer (gel-fraction highly changing pressure-sensitive adhesive layer)

3 die-adhering layer

4 separator

### DETAILED DESCRIPTION OF THE INVENTION

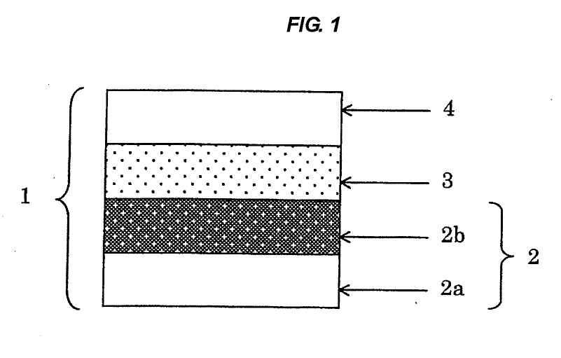

Embodiments of the present invention are described with reference to FIG. 1 but the invention is not limited to these embodiments. FIG. 1 is a cross-sectional schematic view showing one example of the laminated film of the invention. In FIG. 1, 1 is a laminated film (pressure-sensitive adhesive sheet fitted with die-adhering layer), 2 is a pressure-sensitive adhesive sheet, 2a is a base material, 2b is a pressure-sensitive adhesive layer (gel-fraction highly changing pressure-sensitive adhesive layer), 3 is a die-adhering layer, and 4 is a separator. However, parts that are unnecessary for the description are not given, and there are parts shown by magnifying, minifying, etc. in order to make the description easy.

The pressure-sensitive adhesive sheet 1 fitted with the die-adhering layer shown in FIG. 1 is constituted by the base material 2a, the gel-fraction highly changing pressure-sensitive adhesive layer 2b formed on one surface of the base material 2a, the die-adhering layer 3 formed on the gel-fraction highly changing pressure-sensitive adhesive layer 2b, and further the separator 4 formed on the die-adhering layer 3. In the pressure-sensitive adhesive sheet 1 fitted with the die-adhering layer, the pressure-sensitive adhesive sheet 2 is constituted by the base material 2a and the gel-fraction highly changing pressure-sensitive adhesive layer 2b. The gel-fraction highly changing pressure-sensitive adhesive layer 2b is a pressure-sensitive adhesive layer formed of a pressure-sensitive adhesive composition containing a base polymer and a thermal crosslinking agent and is a pressure-sensitive adhesive layer where a gel fraction before heating is less than 90% by weight and a gel fraction after heating is changed to 90% by weight or more.

Incidentally, in the pressure-sensitive adhesive sheet 1 fitted with the die-adhering layer according to the invention, for the pressure-sensitive adhesive sheet 2, an intermediate layer such as a rubbery organic elastic layer can be arbitrarily provided between the base material 2a and the gel-fraction highly changing pressure-sensitive adhesive layer 2b. Moreover, in the pressure-sensitive adhesive sheet fitted with the die-adhering layer according to the invention, the pressure-sensitive adhesive sheet may have a constitution that the gel-fraction highly changing pressure-sensitive adhesive layer is provided on one surface of the base material or may have a constitution that the gel-fraction highly changing pressure-sensitive adhesive layer is provided on each surface of the base material. In this regard, in the pressure-sensitive adhesive sheet fitted with the die-adhering layer, in the case where the pressure-sensitive adhesive sheet has a constitution that the gel-fraction highly changing pressure-sensitive adhesive layer is provided only on one surface of the base material, the pressure-sensitive adhesive sheet may have a constitution that a pressure-sensitive adhesive layer other than the gel-fraction highly changing pressure-sensitive adhesive layer is provided on the other surface of the base material.

### Base Material

The base material (supporting substrate) can be used as a supporting base material for the gel-fraction highly changing pressure-sensitive adhesive layer and the like. As the base material, for example, suitable thin bodies, e.g., paper-based base materials such as paper; fiber-based base materials such as fabrics, non-woven fabrics, felts, and nets; metal-based base materials such as metal foils and metal plates; plastic base materials such as plastic films and sheets; rubber-based base materials such as rubber sheets; foamed bodies such as foamed sheets; and laminates thereof [particularly, laminates of plastic based materials with other base materials, laminates of plastic films (or sheets) each other, etc.] can be used. As the base material, one excellent in thermal resistance which does not melt at a heating treatment temperature of the gel-fraction highly changing pressure-sensitive adhesive layer is preferred from the viewpoints of handling ability after heating and the like. In the invention, as the base material, plastic base materials such as plastic films and sheets can be suitably employed. Examples of raw materials for such plastic materials include olefinic resins such as polyethylene (PE), polypropylene (PP), and ethylene-propylene copolymers; copolymers using ethylene as a monomer component, such as ethylene-vinyl acetate copolymers (EVA), ionomer resins, ethylene-(meth)acrylic acid copolymers, and ethylene-(meth)acrylic acid ester (random, alternating) copolymers; polyesters such as polyethylene terephthalate (PET), polyethylene naphthalate (PEN), and polybutylene terephthalate (PBT); acrylic resins; polyvinyl chloride (PVC); polyurethanes; polycarbonates; polyphenylene sulfide (PPS); amide-based resins such as polyamides (Nylon) and whole aromatic polyamides (aramide); polyether ether ketones (PEEK); polyimides; polyetherimides; polyvinylidene chloride; ABS (acrylonitrile-butadiene-styrene copolymers); cellulose-based resins; silicone resins; and fluorinated resins. Moreover, as the material of the base material, a polymer such as a cross-linked body of each of the above resins can also be used. These raw materials may be used solely or two or more kinds thereof can be used in combination.

In the case where a plastic base material is used as the base material, deformation properties such as an elongation percent may be controlled by a stretching treatment or the like.

The surface of the base material may be subjected to a commonly used surface treatment, e.g., an oxidation treatment by a chemical or physical method, such as a chromate treatment, ozone exposure, flame exposure, exposure to high-voltage electric shock, or an ionizing radiation treatment, or may be subjected to a coating treatment with a coating agent such as an anchor coating agent, a primer, or an adhesive in order to enhance the close adhesion to the gel-fraction highly changing pressure-sensitive adhesive layer, the holding properties, and the like. For preventing the peeling of the base material from the gel-fraction highly changing pressure-sensitive adhesive layer at the peeling of the pressure-sensitive adhesive sheet from the die-adhering layer by changing the gel fraction of the gel-fraction highly changing pressure-sensitive adhesive layer to 90% by weight or more, the above-described surface treatment or coating treatment is preferably applied particularly on the surface at the gel-fraction highly changing pressure-sensitive adhesive layer side of the base material. Both of the surface treatment and the coating treatment may be applied. Examples of the anchor coating agent include organic titanate-based, polyethyleneimine-based, polybutadiene-based, isocyanate-based, and polyester-based anchor coating agents. Moreover, examples of the adhesive include polyester-based, polyurethane-based, and polyester-based adhesives. As the adhesive, polyurethane-based adhesives can be suitably used.

In this regard, in the case where the pressure-sensitive adhesive sheet fitted with the die-adhering layer has a constitution that it is wound in a roll form without protecting the die-adhering layer with a separator, for imparting peeling ability against the die-adhering layer surface to the rear surface of the base material, for example, a coating treatment with a releasant (releasing agent) such as a silicone-based resin or a fluorine-based resin may be applied.

Incidentally, the base material may contain various additives (coloring agents, fillers, plasticizers, antiaging agents, antioxidants, surfactants, flame retardants, etc.) within the range where the advantages and the like of the invention are not impaired.

The thickness of the base material is not particularly restricted and can be appropriately selected depending on strength, flexibility, intended purpose of use, and the like. For example, the thickness is generally 1,000 μm or less (e.g., 1 μm to 1,000 μm), preferably 1 μm to 500 μm, further preferably 3 μm to 300 μm, and particularly about 5 μm to 250 μm but is not limited thereto. In this regard, the base material may have any form of a single layer form and a laminated form.

### Gel-Fraction Highly Changing Pressure-Sensitive Adhesive Layer

The gel-fraction highly changing pressure-sensitive adhesive layer is a pressure-sensitive adhesive layer formed of a pressure-sensitive adhesive composition containing a base polymer and a thermal crosslinking agent and is a pressure-sensitive adhesive layer where a gel fraction thereof before heating is less than 90% by weight and a gel fraction thereof after heating is changed to 90% by weight or more. The heating temperature at the time when the gel fraction of the gel-fraction highly changing pressure-sensitive adhesive layer after heating is changed to 90% by weight or more can be suitably selected depending on the composition and constitution of the gel-fraction highly changing pressure-sensitive adhesive layer and also the composition and constitution of the other layers (base material, die-adhering layer, etc.) of the pressure-sensitive adhesive sheet fitted with the die-adhering layer and the like. For example, in the case where the gel fraction is changed to 90% by weight or more using a thermal crosslinking agent as shown below, it is important that the heating temperature at the time when the gel fraction of the gel-fraction highly changing pressure-sensitive adhesive layer after heating is changed to 90% by weight or more is a temperature equal to or higher than the temperature at which a crosslinking reaction of the thermal crosslinking agent proceeds and a temperature at which the die-adhering layer is not cured. Specifically, the heating temperature at the time when the gel fraction of the gel-fraction highly changing pressure-sensitive adhesive layer after heating is changed to 90% by weight or more is, for example, preferably 100° C. or higher and lower than 250° C. and particularly, is suitably 110° C. or higher and lower than 200° C. Therefore, in the gel-fraction highly changing pressure-sensitive adhesive layer, it is suitable that the gel fraction thereof is not changed to 90% by weight or more at a temperature lower than 100° C. (particularly lower than 110° C.). As above, when the gel-fraction highly changing pressure-sensitive adhesive layer has such a constitution that the gel fraction can be changed to 90% by weight or more at a temperature of 100° C. or higher and lower than 250° C. (particularly, 110° C. or higher and lower than 200° C.), in the pressure-sensitive adhesive sheet fitted with the die-adhering layer, the pressure-sensitive adhesive force between the gel-fraction highly changing pressure-sensitive adhesive layer and the die-adhering layer can be sufficiently lowered by effectively changing the gel fraction of the gel-fraction highly changing pressure-sensitive adhesive layer to 90% by weight or more, whereby a semiconductor chip fitted with the die-adhering layer can be peeled from the gel-fraction highly changing pressure-sensitive adhesive layer of the pressure-sensitive adhesive sheet with a low fouling degree.

It is necessary that the gel-fraction highly changing pressure-sensitive adhesive layer has a gel fraction (insoluble fraction) before the heating treatment of less than 90% by weight. The gel fraction before heating of the gel-fraction highly changing pressure-sensitive adhesive layer is preferably 85% by weight or less, further preferably 80% by weight or less. As above, since the gel fraction before heating of the gel-fraction highly changing pressure-sensitive adhesive layer is less than 90% by weight, the die-adhering layer and the gel-fraction highly changing pressure-sensitive adhesive layer can be well closely adhered and thus occurrence of chip fly at cutting a semiconductor wafer can be suppressed or prevented.

Moreover, in the gel-fraction highly changing pressure-sensitive adhesive layer, it is necessary that the gel fraction (insoluble fraction) after the heating treatment is changed to 90% by weight or more. The gel fraction after heating of the gel-fraction highly changing pressure-sensitive adhesive layer is preferably 92% by weight or more, further preferably 96% by weight or more. As above, since the gel fraction after heating of the gel-fraction highly changing pressure-sensitive adhesive layer is 90% by weight or more, the close adhesion between the die-adhering layer and the gel-fraction highly changing pressure-sensitive adhesive layer decreases and the pressure-sensitive adhesive force decreases, so that the gel-fraction highly changing pressure-sensitive adhesive layer can be easily peeled from the die-adhering layer in the pressure-sensitive adhesive sheet. Accordingly, a cut semiconductor wafer can be easily picked up and thus a semiconductor wafer fitted with the die-adhering layer can be efficiently obtained. Moreover, at the time when the gel-fraction highly changing pressure-sensitive adhesive layer is peeled from the die-adhering layer, the fouling of the die-adhering layer due to a remaining of the pressure-sensitive adhesive composition on the die-adhering layer though cohesive failure of the gel-fraction highly changing pressure-sensitive adhesive layer can be effectively suppressed or prevented.

In the invention, the gel fraction (gel fraction before heating or gel fraction after heating) of the gel-fraction highly changing pressure-sensitive adhesive layer can be measured by the following measurement method.

### <Gel Fraction Measurement Method>

About 0.1 g of a sample is sampled from the gel-fraction highly changing pressure-sensitive adhesive layer before heating or after heating and precisely weighed (Weight of Sample) and, after the sample is wrapped in a mesh-type sheet, is immersed in about 50 mL of toluene at room temperature for 1 week. Thereafter, a solvent-insoluble matter (content in the mesh-type sheet) is taken out of the toluene and dried at 130° C. for about 2 hours, a solvent-insoluble matter after drying is weighed (Weight after Immersion and Drying), and then the gel fraction (% by weight) is calculated according to the following equation (a).

Gel Fraction (% by weight)=[(Weight after Immersion and Drying)/(Weight of Sample)]×100 (a)

Incidentally, it is important that the heating temperature regarding the “gel-fraction highly changing pressure-sensitive adhesive layer after heating” at the measurement of the gel fraction of the gel-fraction highly changing pressure-sensitive adhesive layer is a crosslinking reaction proceeding temperature of the thermal crosslinking agent contained for controlling the gel fraction of the gel-fraction highly changing pressure-sensitive adhesive layer or higher. Specifically, the temperature is suitably 100° C. or higher and lower than 250° C., particularly 110° C. or higher and lower than 200° C.

In the invention, the gel fraction (i.e., gel fraction before heating and after heating) of the gel-fraction highly changing pressure-sensitive adhesive layer can be controlled by adjusting the composition of the base polymer of the pressure-sensitive adhesive for forming the gel-fraction highly changing pressure-sensitive adhesive layer, the kind and content of the thermal crosslinking agent to be added to the pressure-sensitive adhesive, and the like.

### (Pressure-Sensitive Adhesive)

The pressure-sensitive adhesive for forming the gel-fraction highly changing pressure-sensitive adhesive layer is a pressure-sensitive adhesive composition containing the base polymer and the thermal crosslinking agent, where the gel fraction (gel fraction before heating) at the time when the pressure-sensitive adhesive layer is formed and the gel fraction after heating each are a prescribed value. As such a pressure-sensitive adhesive, for example, a pressure-sensitive adhesive agent having the above-described characteristics can be suitably selected from known pressure-sensitive adhesives such as acrylic pressure-sensitive adhesives, rubber-based pressure-sensitive adhesives, vinyl alkyl ether-based pressure-sensitive adhesives, silicone-based pressure-sensitive adhesives, polyester-based pressure-sensitive adhesives, polyamide-based pressure-sensitive adhesives, urethane-based pressure-sensitive adhesives, fluorine-based pressure-sensitive adhesives, styrene-diene block copolymer-based pressure-sensitive adhesives, and creeping property-improvable pressure-sensitive adhesives where a heat-meltable resin having a melting point of about 200° C. or lower is blended in these pressure-sensitive adhesives (see, e.g., JP-A-56-61468, JP-A-61-174857, JP-A-63-17981, JP-A-56-13040, and the like, which are herein incorporated by reference). Moreover, as the pressure-sensitive adhesive, a radiation ray-curable pressure-sensitive adhesive (or an energy ray curable pressure-sensitive adhesive) can be also used. The pressure-sensitive adhesives can be used solely or two or more kinds thereof can be used in combination. Incidentally, in the case where the pressure-sensitive adhesive is constituted by two or more kinds of pressure-sensitive adhesives, it is important that the pressure-sensitive adhesive constituted by two or more kinds of pressure-sensitive adhesives has the above-described characteristics.

In the invention, as the pressure-sensitive adhesive, rubber-based pressure-sensitive adhesives using natural rubber or any of various synthetic rubbers (such as polyisoprene rubber, styrene-butadiene rubber, styrene-isoprene-styrene block copolymeric rubber, styrene-butadiene-styrene block copolymeric rubber, reclaimed rubber, butyl rubber and isobutylene) as a base polymer or acrylic pressure-sensitive adhesives using an acrylic polymer as a base polymer can be suitably used. Of these, acrylic pressure-sensitive adhesives are particularly preferred.

As the acrylic pressure-sensitive adhesive, those containing an acrylic polymer using one or more kinds of (meth)acrylic acid alkyl esters as monomer component(s) can be suitably used. Examples of the (meth)acrylic acid alkyl esters include (meth)acrylic acid alkyl esters having an alkyl group having 1 to 20 carbon atoms, such as methyl(meth)acrylate, ethyl(meth)acrylate, propyl(meth)acrylate, isopropyl(meth)acrylate, butyl(meth)acrylate, isobutyl(meth)acrylate, s-butyl(meth)acrylate, t-butyl(meth)acrylate, pentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, hexadecyl(meth)acrylate, heptadecyl(meth)acrylate, octadecyl(meth)acrylate, nonadecyl(meth)acrylate, and eicosyl(meth)acrylate, and the like. As the (meth)acrylic acid alkyl esters, (meth)acrylic acid alkyl esters having an alkyl group having 2 to 14 carbon atoms are suitable and further preferred are (meth)acrylic acid alkyl esters having an alkyl group having 2 to 10 carbon atoms. Incidentally, the alkyl group of the (meth)acrylic acid alkyl ester may be any of linear chain and branched chain ones.

Among such (meth)acrylic acid alkyl esters, an acrylic acid alkyl ester having an alkyl group having 6 to 10 carbon atoms [CH₂═CHCOOR (R is an alkyl group having 6 to 10 carbon atoms)] is preferred and among them, an acrylic acid alkyl ester having an alkyl group having 8 or 9 carbon atoms is suitable. When the acrylic acid alkyl ester having an alkyl group having 6 to 10 carbon atoms is used as the (meth)acrylic acid alkyl ester, the peeling force of the gel-fraction highly changing 2 0 pressure-sensitive adhesive layer against the die-adhering layer can be controlled to an appropriate degree and a good picking-up property can be exhibited. Moreover, the gel-fraction highly changing pressure-sensitive adhesive layer can exhibits an appropriate close adhesion with the die-adhering layer and thus chip fly at the dicing can be effectively suppressed or prevented. In the invention, as the acrylic acid alkyl ester having an alkyl group having 6 to 10 carbon atoms, 2-ethylhexyl acrylate and isooctyl acrylate are particularly preferred.

In the case where the acrylic acid alkyl ester having an alkyl group having 6 to 10 carbon atoms is used as the (meth)acrylic acid alkyl ester, it is suitable that the content of the acrylic acid alkyl ester having an alkyl group having 6 to 10 carbon atoms is preferably 50 to 99% by mol, more preferably 80 to 99% by mol, particularly 90 to 99% by mol, based on the whole monomer components. When the content of the acrylic acid alkyl ester having an alkyl group having 6 to 10 carbon atoms is less than 50% by mol based on the whole monomer components, the peeling force of the gel-fraction highly changing pressure-sensitive adhesive layer against the die-adhering layer becomes too large, so that there is a case where the pick-up property decreases. On the other hand, when the content exceeds 99% by mol, the pressure-sensitive adhesiveness decreases and there is a case that chip fly is generated at the dicing.

Moreover, according to the invention, in the acrylic polymer as a base polymer of the acrylic pressure-sensitive adhesive, (meth)acrylic acid esters having an alicyclic hydrocarbon group such as cyclopentyl(meth)acrylate, cyclohexyl(meth)acrylate, and isobornyl(meth)acrylate and (meth)acrylic acid esters having an aromatic hydrocarbon group can be also used as a monomer component.

Incidentally, for the purpose of modification of the cohesive force, the adhesive force to the die-adhering layer, the thermal resistance, the crosslinking ability, and the like, the above-described acrylic polymer may contain a unit corresponding to another monomer component copolymerizable with the above-described (meth)acrylic acid alkyl esters (a copolymerizable monomer component) according to needs. One or more kinds of the copolymerizable monomer components can be used. As the copolymerizable monomer components, polar group-containing monomers, polyfunctional monomers or oligomers, and the like may be mentioned. In this regard, in the invention, “polyfunctional oligomers” are also included in the category of the monomers for the sake of convenience.

Examples of the polar group-containing monomers include carboxyl group-containing monomers such as (meth)acrylic acid (acrylic acid, methacrylic acid), carboxyethyl acrylate, carboxypentyl acrylate, itaconic acid, maleic acid, fumaric acid, crotonic acid, and isocrotonic acid; acid anhydride group-containing monomers such as maleic anhydride and itaconic anhydride; hydroxyl group-containing monomers such as hydroxyethyl(meth)acrylate, hydroxypropyl(meth)acrylate, hydroxybutyl(meth)acrylate, hydroxyhexyl(meth)acrylate, hydroxyoctyl(meth)acrylate, hydroxydecyl(meth)acrylate, hydroxylauryl(meth)acrylate, and (4-hydroxymethylcyclohexyl)methyl methacrylate; glycol-based acrylic ester monomers such as polyethylene glycol(meth)acrylate, polypropylene glycol(meth)acrylate, methoxyethylene glycol(meth)acrylate, and methoxypolypropylene glycol(meth)acrylate; sulfonic acid group-containing monomers such as styrenesulfonic acid, sodium vinylsulfonate, allylsulfonic acid, 2-(meth)acrylamido-2-methylpropanesulfonic acid, (meth)acrylamidopropanesulfonic acid, sulfopropyl(meth)acrylate, and (meth)acryloyloxynaphthalenesulfonic acid; phosphoric acid group-containing monomers such as 2-hydroxyethylacryloyl phosphate; (N-substituted)amide-based monomers such as (meth)acrylamide, N,N-dimethyl(meth)acrylamide, N-butyl(meth)acrylamide, N-methylol(meth)acrylamide, N-methylolpropane(meth)acrylamide, N-methoxymethyl(meth)acrylamide, and N-butoxymethyl(meth)acrylamide; aminoalkyl(meth)acrylate-based monomers such as aminoethyl(meth)acrylate, N,N-dimethylaminoethyl(meth)acrylate, and t-butylaminoethyl(meth)acrylate; alkoxyalkyl(meth)acrylate-based monomers such as methoxyethyl(meth)acrylate and ethoxyethyl(meth)acrylate; maleimide-based monomers such as N-cyclohexylmaleimide, N-isopropylmaleimide, N-laurylmaleimide, and N-phenylmaleimide; itaconimide-based monomers such as N-methylitaconimide, N-ethylitaconimide, N-butylitaconimide, N-octylitaconimide, N-2-ethylhexylitaconimide, N-laurylitaconimide, and N-cyclohexylitaconimide; succinimide-based monomers such as N-(meth)acryloyloxymethylenesuccinimide, N-(meth)acryloyl-6-oxyhexamethylenesuccinimide, and N-(meth)acryloyl-8-oxyoctamethylenesuccinimide; vinyl ester-based monomers such as vinyl acetate and vinyl propionate; heterocycle-containing monomers such as N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, and N-vinylcaprolactam; N-vinylcarboxylic acid amides; vinyl alkyl ether-based monomers such as vinyl methyl ether and vinyl ethyl ether; cyanoacrylate monomers such as acrylonitrile and methacrylonitrile; epoxy group-containing monomers such as glycidyl(meth)acrylate and methylglycidyl(meth)acrylate; heterocycle-containing(meth)acrylic acid esters such as tetrahydrofurfuryl(meth)acrylate; and silicon atom-containing monomers such as silicone(meth)acrylate. Among these polar group-containing monomers, carboxyl group-containing monomers such as acrylic acid and acid anhydride group-containing monomers are particularly preferred.

The content of the polar group-containing monomer is in the range of preferably 1% by mol to 10% by mol, further preferably 5% by mol to 10% by mol based on the whole amount of the monomer components. When the content of the polar group-containing monomer component is less than 1% by mol based on the whole amount of the monomer components, there is a case where crosslinking is insufficient and the picking-up property decreases. On the other hand, when the content exceeds 10% by mol, the polarity of the pressure-sensitive adhesive increases and there is a case where peeling becomes difficult through an increase in interaction with the die-adhering layer.

Examples of the polyfunctional monomer include hexanediol di(meth)acrylate, (poly)ethylene glycol di(meth)acrylate, (poly)propylene glycol di(meth)acrylate, neopentyl glycol di(meth)acrylate, pentaerythritol tri(meth)acrylate, pentaerythritol di(meth)acrylate, pentaerythritol(meth)acrylate, dipentaerythritol hexa(meth)acrylate, trimethyloipropane tri(meth)acrylate, tetramethylolmethane tri(meth)acrylate, allyl(meth)acrylate, vinyl(meth)acrylate, divinylbenzene, butyl di(meth)acrylate, and hexyl di(meth)acrylate. Examples of the polyfunctional oligomer include oligomers having a (meth)acryloyl group at the molecular end, such as polyfunctional urethane (meth)acrylate-based oligomers, polyfunctional ester (meth)acrylate-based oligomers, polyfunctional epoxy(meth)acrylate-based oligomers, and polyfunctional melamine(meth)acrylate-based oligomers.

It is desirable that the amount of the polyfunctional monomer or oligomer to be used is 7% by weight or less (e.g., 0.01% by weight to 7% by weight, preferably 0.5% by weight to 5% by weight, further preferably 0.6% by weight to 3% by weight) based on the whole amount of the monomer components. When the amount of the polyfunctional monomer or oligomer to be used exceeds 7% by weight based on the whole amount of the monomer components, there is a concern that the dispersing property of thermal crosslinking agent decreases or the pressure-sensitive adhesive force decreases due to excessively high cohesive force of the acrylic pressure-sensitive adhesive. In this regard, when the amount of the polyfunctional monomer or oligomer to be used is less than 0.01% by weight based on the whole amount of the monomer components, for example, the cohesive force of the acrylic pressure-sensitive adhesive is apt to decrease.

With regard to the copolymerizable monomer component(s), examples of the monomer components other than the above-mentioned ones include styrene-based monomers such as styrene, vinyltoluene, and α-methylstyrene; olefins or dienes such as ethylene, butadiene, isoprene, and isobutylene; halogen atom-containing monomers such as vinyl chloride and vinylidene chloride; and fluorine atom-containing monomers such as fluorinated (meth)acrylates.

Incidentally, the acrylic pressure-sensitive adhesive can be prepared using the above-mentioned monomer component(s) and utilizing any of known polymerization techniques such as solution polymerization (e.g., radical polymerization, anion polymerization, cation polymerization, etc.), emulsion polymerization, and photopolymerization (e.g., ultraviolet ray (UV) polymerization, etc.).

### (Thermal Crosslinking Agent)

In the invention, a thermal crosslinking agent is used and the gel fraction after heating of the gel-fraction highly changing pressure-sensitive adhesive layer can be controlled to 90% by weight or more by using the thermal crosslinking agent. In this regard, the thermal crosslinking agent may be one which constructs a crosslinked structure through the reaction with a functional group such as a hydroxyl group, a carboxyl group, an amino group, or an amide group which has been introduced as a crosslinking base point into the base polymer structure in the pressure-sensitive adhesive composition, may be one which constructs a crosslinked structure through the reaction with a crosslinking agent-reactive component (e.g., a polyol compound, a polycarboxylic acid compound, a polyamine compound, etc.) which has been added into the pressure-sensitive adhesive composition, or may be one which constructs a crosslinked structure between the thermal crosslinking agents. The thermal crosslinking agents can be used solely or two or more kinds thereof can be used in combination.

The thermal crosslinking agent is preferably a thermal crosslinking agent wherein a temperature at which the crosslinking reaction proceeds is 100° C. or higher and lower than 250° C., and a thermal crosslinking agent wherein the temperature is 110° C. or more and lower than 200° C. is suitable. When the crosslinking reaction proceeding temperature is lower than 100° C., there is a case where a crosslinking reaction of the thermal crosslinking agent occurs during the drying step at the production of the pressure-sensitive adhesive sheet. On the other hand, when the temperature is 200° C. or higher, there is a concern that the die-adhering layer is cured and the function as an adhesive is impaired.

In the invention, the thermal crosslinking agent means an addition reaction product (blocked crosslinking agent) of a compound, which undergoes an addition reaction with a free functional group donating the crosslinking reaction (crosslinking-reactive functional group) in the crosslinking molecule to inactivate the group but is easily dissociated by heating to regenerate the functional group in an active state (sometimes referred to as a “blocking agent”), with a crosslinking agent. Namely, the thermal crosslinking agent (“blocked crosslinking agent”) is such a crosslinking agent that the crosslinking-reactive functional groups in the crosslinking agent are inactivated with the blocking agent (block agent) before heating and at least two or more functional groups are activated in one molecule through the dissociation of the blocking agent from the functional group by heating.

In the thermal crosslinking agent, the crosslinking agent which undergoes an addition reaction with the blocking agent is not particularly limited and examples thereof include isocyanate-based crosslinking agents, epoxy-based crosslinking agents, melamine-based crosslinking agents, amine-based crosslinking agents, aziridine-based crosslinking agents, metal chelate compounds, peroxide-based crosslinking agents, urea-based crosslinking agents, metal alkoxide-based crosslinking agents, metal salt-based crosslinking agents, carbodiimide-based crosslinking agents, and oxazoline-based crosslinking agents. Moreover, as the blocking agent, there can be used a compound capable of undergoing an addition reaction with the crosslinking-reactive functional group of the crosslinking agent to inactivate it.

In the invention, as the thermal crosslinking agent, a commercially available product can be used and also the thermal crosslinking agent may be a thermal crosslinking agent (blocked crosslinking agent) obtained by inactivating any of various crosslinking agents with the blocking agent by a conventionally known method. As the thermal crosslinking agent, particularly, a blocked isocyanate (isocyanate-based blocked crosslinking agent) obtained by blocking an isocyanate compound with the blocking agent can be suitably used.

As the isocyanate compound for use in the blocked isocyanate, a compound having two or more isocyanate groups in one molecule can be suitably used. Examples of the isocyanate compound include diisocyanates, e.g., aliphatic diisocyanates such as ethylene diisocyanate, tetramethylene diisocyanate, hexamethylene diisocyanate, 2,4,4- or 2,2,4-trimethylhexamethylene diisocyanate, and methyl 2,6-diisocyanatocaproate; alicyclic diisocyanates such as 3-isocyanatomethyl-3,5,5-trimethylcyclohexane, 1,3- or 1,4-bis(isocyanatomethyl)cyclohexane, methylcyclohexan-2,4-or 2,6-diisocyanate, dicyclohexylmethan-4,4′-diisocyanate, and 1,3- or 1,4-diisocyanatocyclohexane; aromatic diisocyanates such as m- or p-phenylene diisocyanate, diphenylmethan-4,4′-diisocyanate, and 2,4- or 2,6-tolylene diisocyanate; aromatic-aliphatic diisocyanates such as 1,3′- or 1,4-bis(isocyanatomethyl)benzene and 1,3- or 1,4-bis(α-isocyanatoisopropyl)benzene; and the like.

Moreover, as the isocyanate compound, there may be used triisocyanates such as triphenylmethane-4,4′,4″-triisocyanate, 1,3,5-triisocyanatobenzene, 1,3,5-tris(isocyanatomethyl)cyclohexane, 1,3,5-tris(isocyanatomethyl)benzene, and 2-isocyanatoethyl 2,6-diisocyanatocaproate. Furthermore, as the isocyanate compound, for example, there may be used polymerized polyisocyanates such as dimers and trimers 2 5 of diisocyanates; polymethylene polyphenylene polyisocyanates; polyisocyanates obtainable by reacting excess of the above isocyante compounds with active hydrogen-containing low-molecular-weight compounds such as ethylene glycol, propylene glycol, dipropylene glycol, diethylene glycol, triethylene glycol, 2,2,4-trimethyl-1,3-pentanediol, neopentyl glycol, hexanediol, cyclohexanedimethanol, cyclohexanediol, hydrogenated bisphenol A, xylylene glycol, glycerin, trimethylolethane, trimethylolpropane, hexanetriol, pentaerythritol, sorbitol, sorbit, sucrose, castor oil, ethylenediamine, hexamethylenediamine, diethanolamine, triethanolamine, water, ammonia, and urea or active hydrogen-containing high-molecular-weight compounds such as various polyether polyols, polyester polyols, polyurethane polyols, acryl polyols, and epoxy polyols; or polyisocyanates such as allophanated polyisocyanates and biuret polyisocyanates thereof.

The isocyanate compounds can be used solely or as a mixture of two or more kinds thereof.

The above-described blocking agent can be suitably selected from the hitherto known blocking agents and used. Examples of the blocking agents include phenol-based blocking agents such as phenol, cresol, ethylphenol, butylphenol, p-nonylphenol, catechol, nitrophenol, and hydroxybenzoic acid esters; lactam-based blocking agents such as ε-caprolactam, δ-valerolactam, and γ-butyrolactam; active methylene-based blocking agents such as dimethyl malonate, diethyl malonate, methyl acetoacetate, ethyl acetoacetate, and acetylacetone; alcohol-based blocking agents such as methanol, ethanol, isopropyl alcohol, tert-butyl alcohol, lauryl alcohol, ethylene glycol monoethyl ether, trimethylolpropane, cyclohexanol, benzyl alcohol, glycolic acid, glycolic acid esters, lactic acid, lactic acid esters, diacetone alcohol, and ethylene chlorohydrin;

mercaptan-based blocking agents such as butylmercaptan, octylmercaptan, tert-dodecylmercaptan, 2-mercaptobenzothiazole, and thiophenol; acid amide-based blocking agents such as acetanilide, acetamide, acrylamide, and benzamide; imide-based blocking agents such as succinic acid imide, maleic acid imide, and phthalimide; amine-based blocking agents such as diphenylamine, carbazole, aniline, and dibutylamine; imidazole-based blocking agents such as imidazole and 2-ethylimidazole; urea-based blocking agents such as urea, thiourea, and ethylenethiourea; pyrazoles such as 3,5-dimethylpyrazole; triazoles such as 1,2,4-triazole; carbamic acid ester-based blocking agents such as 2-oxazolidone and phenyl N-phenylcarbamate; oxime-based blocking agents such as formaldoxime, acetaldoxime, acetoxime, methyl ethyl ketoxime, methyl isobutyl ketoxime, methyl isoamyl ketoxime, acetophenone oxime, diacetyl monoxime, cyclohexanone oxime, and benzophenone oxime; sulfite-based blocking agents such as sodium hydrogen sulfite and potassium hydrogen sulfite; and N,N′-diarylformamidines such as N,N′-diphenylformamidine, N,N′-bis(2-methylphenyl)formamidine, N,N′-bis(3-methylphenyl)formamidine, N,N′-bis(4-methylphenyl)formamidine, and N,N′-bis(3,5-dimethylphenyl)formamidine. The blocking agents can be used solely or two or more kinds thereof can be used in combination.

As the blocked isocyanate, a commercially available product can be used and also the blocked isocyanate can be prepared by a known method and used. The blocked isocyanate can be obtained by reacting a polyisocyanate with a blocking agent as mentioned above. For example, the blocked isocyanate can be obtained by stirring an isocyanate compound and a blocking agent at a temperature of about 0 to 200° C. in a solvent and separating a product thereof using a known separation and purification method such as concentration, filtration, extraction, crystallization, and/or distillation. The reaction of the isocyanate compound with the blocking agent can be carried out in a solvent having no active hydrogen or can be carried out without any solvent. Examples of the solvent having no active hydrogen include ester-based solvents such as ethyl acetate, butyl acetate, cellosolve acetate, carbitol acetate, and dimethyl esters of dibasic acids; ketone-based solvents such as methyl ethyl ketone, methyl isobutyl ketone, and cyclohexanone; aromatic solvents such as toluene, xylene, Solvesso #100, and Solvesso #150.

The content of the thermal crosslinking agent in the pressure-sensitive composition constituting the gel-fraction highly changing pressure-sensitive adhesive layer can be appropriately selected in the range where the gel fraction, adhesiveness, and easy peeling ability of the gel-fraction highly changing pressure-sensitive adhesive layer are not impaired but is, for example, 0.1 part by weight to 50 parts by weight, preferably 1 part by weight to 30 parts by weight based on 100 parts by weight (in terms of solid matter) of the base polymer (particularly, acrylic polymer).

In addition to the base polymer as a main body of the pressure-sensitive adhesive and the thermal crosslinking agent, the gel-fraction highly changing pressure-sensitive adhesive layer or the pressure-sensitive adhesive composition constituting the gel-fraction highly changing pressure-sensitive adhesive layer may contain, for example, appropriate additives such as photopolymerization initiators, thermal polymerization initiators, tackifiers (e.g., those composed of rosin derivative resins, polyterpene resins, petroleum resins, oil-soluble phenol resins, or the like, which are solid, semi-solid, or liquid at ordinary temperature), plasticizers, antiaging agents, antioxidants, thickening agents (viscosity regulators), surfactants, and coloring agents. Moreover, the gel-fraction highly changing pressure-sensitive adhesive layer or the pressure-sensitive adhesive composition may contain catalysts for promoting the dissociation of the thermal crosslinking agent and crosslinking agent-reactive components (e.g., polyol compounds, polycarboxylic acid compounds, polyamine compounds, etc.) for the purpose of enhancing cohesive force of the pressure-sensitive adhesive layer or enhancing the peeling ability at heating.

Incidentally, in the invention, it is also possible to perform the crosslinking treatment by irradiation with an electron beam or ultraviolet ray together with the use of the thermal crosslinking agent.

### (Manufacturing Method of Gel-Fraction Highly Changing Pressure-Sensitive Adhesive Layer)

The gel-fraction highly changing pressure-sensitive adhesive layer can be produced via a step of forming a gel-fraction highly changing pressure-sensitive adhesive layer constituted by a pressure-sensitive adhesive composition containing a base polymer and a thermal crosslinking agent on a separator (release liner) or a base material. In the case where the gel-fraction highly changing pressure-sensitive adhesive layer is formed on the separator, a pressure-sensitive adhesive sheet having the gel-fraction highly changing pressure-sensitive adhesive layer laminated on a base material can be manufactured by transcribing (transferring) the gel-fraction highly changing pressure-sensitive adhesive layer on the separator to the base material or the like.

The forming method of the gel-fraction highly changing pressure-sensitive adhesive layer is not particularly limited but, in the case where the layer is formed of the pressure-sensitive adhesive using as the base polymer a polymer prepared by solution polymerization, the gel-fraction highly changing pressure-sensitive adhesive layer can be manufactured by preparing a pressure-sensitive adhesive solution containing the base polymer and the thermal crosslinking agent, applying the pressure-sensitive adhesive solution on the separator or the base material utilizing a known application technique to form a coated film, and subsequently subjecting it to a drying step.

The thickness of the gel-fraction highly changing pressure-sensitive adhesive layer varies depending on the use application, the method for the use, and the like but is, for example, about 1 μm to 50 μm, preferably 2 μm to 30 μm, further preferably 5 μm to 25 μm. When the thickness of the gel-fraction highly changing pressure-sensitive adhesive layer is less than 1 μm, there is a case where the fixing and holding of the die-adhering layer is difficult. On the other hand, when the thickness of the gel-fraction highly changing pressure-sensitive adhesive layer exceeds 50 μm, cohesion failure may occur in the gel-fraction highly changing pressure-sensitive adhesive layer at peeling and the pressure-sensitive adhesive components may remain on the surface of the die-adhering layer, so that the surface of the die-adhering layer is apt to be fouled.

The gel-fraction highly changing pressure-sensitive adhesive layer may be either a monolayer or a multilayer.

Incidentally, the pressure-sensitive adhesive sheet including the base material and the gel-fraction highly changing pressure-sensitive adhesive layer may further include an intermediate layer between the base material and the gel-fraction highly changing pressure-sensitive adhesive layer. Such an intermediate layer is not particularly limited and may be a layer corresponding to various intended purposes.

Moreover, in the pressure-sensitive adhesive sheet including the base material and the gel-fraction highly changing pressure-sensitive adhesive layer, the gel-fraction highly changing pressure-sensitive adhesive layer may be formed on at least one surface of the base material. For example, there may be mentioned a pressure-sensitive adhesive sheet in a form that the gel-fraction highly changing pressure-sensitive adhesive layer is formed on one surface of the base material, a pressure-sensitive adhesive sheet in a form that the gel-fraction highly changing pressure-sensitive adhesive layer is formed on each surface of the base material, a pressure-sensitive adhesive sheet in a form that the gel-fraction highly changing pressure-sensitive adhesive layer is formed on one surface of the base material and a pressure-sensitive adhesive layer other than the gel-fraction highly changing pressure-sensitive adhesive layer is formed on the other surface, and the like. In this regard, in the case where the gel-fraction highly changing pressure-sensitive adhesive layer is formed on each surface of the base material, in the pressure-sensitive adhesive sheet fitted with the die-adhering layer, the die-adhering layer is formed on the gel-fraction highly changing pressure-sensitive adhesive layer on at least one surface side of the base material. Moreover, in the case where the gel-fraction highly changing pressure-sensitive adhesive layer is formed on each surface of the base material, it is sufficient that the gel-fraction highly changing pressure-sensitive adhesive layer on at least one surface of the base material has the above-described constitutions or characteristics.

Incidentally, the pressure-sensitive adhesive for forming the pressure-sensitive adhesive layer other than the gel-fraction highly changing pressure-sensitive adhesive layer is not particularly limited and known or commonly used pressure-sensitive adhesives such as the pressure-sensitive adhesives exemplified as pressure-sensitive adhesives to be used in the gel-fraction highly changing pressure-sensitive adhesive layer (e.g., acrylic pressure-sensitive adhesives, rubber-based pressure-sensitive adhesives, vinyl alkyl ether-based pressure-sensitive adhesives, silicone-based pressure-sensitive adhesives, polyester-based pressure-sensitive adhesives, polyamide-based pressure-sensitive adhesives, urethane-based pressure-sensitive adhesives, fluorine-based pressure-sensitive adhesives, styrene-diene block copolymer-based pressure-sensitive adhesives, creeping property-improvable pressure-sensitive adhesives, radiation ray-curable pressure-sensitive adhesives, etc.) can be used. These pressure-sensitive adhesives can be used solely or two or more kinds thereof can be used in combination. Moreover, in the pressure-sensitive adhesives for forming the gel-fraction highly changing pressure-sensitive adhesive layer, for example, known or commonly used additives such as tackifiers, coloring agents, thickening agents, extenders, fillers, plasticizers, antiaging agents, surfactants, and crosslinking agents may be blended.

The thickness of the pressure-sensitive adhesive layer other than the gel-fraction highly changing pressure-sensitive adhesive layer may be, for example, 300 μm or less (e.g., 1 μm to 300 μm, preferably 5 μm to 100 μm). Incidentally, as the method of forming the gel-fraction highly changing pressure-sensitive adhesive layer, known or commonly used methods of forming the pressure-sensitive adhesive layer (e.g., a method of application on the base material, a method of application on the separator to form the pressure-sensitive adhesive layer and subsequently transcribing it on the base material, etc.) can be utilized. In this regard, the gel-fraction highly changing pressure-sensitive adhesive layer may be either a monolayer or a multilayer.

### (Pressure-Sensitive Adhesive Force)

With regard to the pressure-sensitive adhesive sheet (pressure-sensitive adhesive sheet constituted by the base material and the gel-fraction highly changing pressure-sensitive adhesive layer) in the pressure-sensitive adhesive sheet fitted with the die-adhering layer, pressure-sensitive adhesive force before the heating treatment [i.e., pressure-sensitive adhesive force in a state that the gel fraction is less than 90% by weight] (temperature: 23° C., peeling angel: 15° , drawing rate: 300 mm/min) is suitably 1 N/10 mm width or more (e.g., 1 N/10 mm width to 10 N/10 mm width), further preferably 1.5 N/10 mm width to 10 N/10 mm width. Incidentally, the pressure-sensitive adhesive force of the pressure-sensitive adhesive sheet before the heating treatment is a value (N/10 mm width) measured by press-bonding a semiconductor wafer having a thickness of 0.6 mm to the die-adhering layer of the pressure-sensitive adhesive sheet fitted with the die-adhering layer at 40° C. (pressure: 1.47×10⁵ Pa, time: 1 minute) by a heat lamination method, subsequently allowing it to stand for 30 minutes under an atmosphere of 23° C., and, after standing, peeling the pressure-sensitive adhesive sheet at the interface between the pressure-sensitive adhesive layer and the die-adhering layer under conditions of a temperature of 23° C., a peeling angle of 15° and a drawing rate of 300 mm/min.

Moreover, with regard to the pressure-sensitive adhesive sheet in the pressure-sensitive adhesive sheet fitted with the die-adhering layer, pressure-sensitive adhesive force after the heating treatment [i.e., pressure-sensitive adhesive force in a state that the gel fraction is 90% by weight or more] (temperature: 23° C., peeling angel: 15°, drawing rate: 300 mm/min) is suitably 5 N/10 mm width or less (e.g., 0 N/10 mm width to 5 N/10 mm width), further preferably 4 N/10 mm width or less (e.g., 0.01 N/10 mm width to 4 N/10 mm width). The pressure-sensitive adhesive force after the heating treatment is, in particular, preferably 3 N/10 mm width or less (e.g., 0.01 N/10 mm width to 3 N/10 mm width), particularly 2.5 N/10 mm width or less (e.g., 0.01 N/10 mm width to 2.5 N/10 mm width). Incidentally, the pressure-sensitive adhesive force of the pressure-sensitive adhesive sheet after the heating treatment is a value (N/10 mm width) measured by press-bonding a semiconductor wafer having a thickness of 0.6 mm to the die-adhering layer of the pressure-sensitive adhesive sheet fitted with the die-adhering layer (pressure: 1.47×10⁵ Pa, time: 1 minute) by a heat lamination method, subsequently allowing it to stand under an atmosphere of 120° C. for 3 minutes and then under an atmosphere of 23° C. for 30 minutes, and, after standing, peeling the pressure-sensitive adhesive sheet at the interface between the pressure-sensitive adhesive layer and the die-adhering layer under conditions of a temperature of 23° C., a peeling angle of 15° and a drawing rate of 300 mm/min.

Therefore, the pressure-sensitive adhesive force (pressure-sensitive adhesive force before the heating treatment, pressure-sensitive adhesive force after the heating treatment) of the pressure-sensitive adhesive sheet in the pressure-sensitive adhesive sheet fitted with the die-adhering layer is a pressure-sensitive adhesive force of the gel-fraction highly changing pressure-sensitive adhesive layer before or after the heating treatment and also a pressure-sensitive adhesive force against the die-adhering layer to which the semiconductor wafer has been attached (die-adhering layer in the semiconductor wafer with the die-adhering layer).

### Die-Adhering Layer

It is important that the die-adhering layer has a function of adhering and supporting a semiconductor wafer during processing of the semiconductor wafer (e.g., cut-processing thereof into a chip form) which has been press-bonded onto the die-adhering layer and a function of acting as an adhering layer of a processed body of the semiconductor wafer (e.g., a semiconductor chip cut into a chip form) to various carriers when the processed body of the semiconductor wafer is mounted. Particularly, as the die-adhering layer, it is important to have such adhesiveness that cut pieces do not fly during processing of the semiconductor wafer (e.g., processing such as cut-processing).

Such a die-adhering layer can have, for example, a constitution of only a single layer of the pressure-sensitive adhesive layer. Moreover, the die-adhering layer may be a multilayer of two or more layers with suitably combining thermoplastic resins different in glass transition temperature and thermosetting resins different in thermal curing temperature. Incidentally, there is a case where cutting water is used in the cutting step of the semiconductor wafer and there is a case where the die-adhering layer absorbs moisture and the moisture content becomes a normal condition or more. When the die-adhering layer is adhered to a substrate or the like with such a high moisture content, water vapor is accumulated at an adhering interface in the stage of after-curing, and there is a case where lifting may occur. Therefore, by making the die-adhering layer have a constitution that a core material having a high moisture permeability is sandwiched with die-adhering layers, water vapor diffuses through the core material in the stage of after-curing and thus such a problem can be avoided. From such a viewpoint, the die-adhering layer may have a multi-layered structure in which the die-adhering layer is formed on one surface or each surface of the core material.

Examples of the core material include films (e.g., polyimide films, polyester films, polyethylene terephthalate films, polyethylene naphthalate films, polycarbonate films, etc.), resin substrates reinforced with a glass fiber or a plastic nonwoven fiber, a silicon substrates, and glass substrates.

The die-adhering layer according to the invention is preferably constituted by a resin composition containing an epoxy resin. In the resin composition, the ratio of the epoxy resin can be appropriately selected from the range of 5% by weight or more, preferably 7% by weight or more, more preferably 9% by weight or more based on the whole amount of the polymer components. An upper limit of the ratio of the epoxy resin is not particularly limited and may be 100% by weight or less, preferably 50% by weight or less, more preferably 40% by weight or less based on the whole amount of the polymer components.

The epoxy resin is preferable from the viewpoint that the content of ionic impurities and the like which corrode a semiconductor element is small. The epoxy resin is not particularly restricted as long as it is generally used as an adhesive composition. For example, a bifunctional epoxy resin or a polyfunctional epoxy resin such as a bispehnol A type epoxy resin, a bisphenol F type epoxy resin, a bisphenol S type epoxy resin, a brominated bisphenol A type epoxy resin, a hydrogenated bisphenol A type epoxy resin, a bisphenol AF type epoxy resin, a biphenyl type epoxy resin, a naphthalene type epoxy resin, a fluorene type epoxy resin, a phenol novolak type epoxy resin, an o-cresol novolak type epoxy resin, a trishydroxyphenylmethane type epoxy resin, and a tetraphenylolethane type epoxy resin, or an epoxy resin such as a hydantoin type epoxy resin, a trisglycidylisocyanurate type epoxy resin or a glycidylamine type epoxy resin may be used. The epoxy resins can be used solely or two or more kinds thereof can be used in combination.

As the epoxy resin, among those exemplified in the above, a novolak type epoxy resin, a biphenyl type epoxy resin, a trishydroxyphenylmethane type epoxy resin, and a tetraphenylolethane type epoxy resin are particularly preferable. This is because these epoxy resins have high reactivity with a phenol resin as a curing agent and are superior in thermal resistance and the like.

Moreover, other thermosetting resins or thermoplastic resins can be used in combination in the die-adhering layer according to needs. Examples of the thermosetting resins include phenol resins, amino resins, unsaturated polyester resins, polyurethane resins, silicone resins, and thermosetting polyimide resins. These thermosetting resins can be used solely or two or more kinds thereof can be used in combination. Here, a phenol resin is preferable as a curing agent for the epoxy resin.

Furthermore, the phenol resin acts as a curing agent for the epoxy resin, and examples thereof include novolak type phenol resins such as phenol novolak resins, phenol aralkyl resins, cresol novolak resins, tert-butylphenol novolak resins, and nonylphenol novolak resins; resol type phenol resins; and polyhydroxystyrenes such as poly-p-hydroxystyrene. They can be used solely or two or more kinds thereof can be used in combination. Among these phenol resins, phenol novolak resins and phenol aralkyl resins are particularly preferable. This is because connection reliability of the semiconductor device can be improved.

The mixing ratio of the epoxy resin to the phenol resin is preferably made, for example, such that the hydroxyl group in the phenol resin becomes 0.5 to 2.0 equivalents per equivalent of the epoxy group in the epoxy resin component. It is more preferably 0.8 to 1.2 equivalents. That is, when the mixing ratio falls outside of the range, a sufficient curing reaction does not proceed, and the characteristics of the epoxy resin cured product is apt to deteriorate.

Examples of the thermoplastic resins include natural rubber, butyl rubber, isoprene rubber, chloroprene rubber, ethylene-vinyl acetate copolymers, ethylene-acrylic acid copolymers, ethylene-acrylate ester copolymers, polybutadiene resin, polycarbonate resins, thermoplastic polyimide resins, polyamide resins such as 6-Nylon and 6,6-Nylon, phenoxy resins, acrylic resins, saturated polyester resins such as PET and PBT, polyamideimide resins, and fluorinated resins. These thermoplastic resins can be used solely or two type or more can be used in combination. Among these thermoplastic resins, acrylic resins are particularly preferable, wherein the ionic impurities are less, the heat resistance is high, and reliability of the semiconductor element can be secured.

The acrylic resins are not particularly restricted, and examples thereof include polymers containing one or more types of acrylic or methacrylic acid esters having a straight chain or branched alkyl group having 30 or less carbon atoms, particularly 4 to 18 carbon atoms as component(s). Examples of the alkyl group include a methyl group, an ethyl group, a propyl group, an isopropyl group, an n-butyl group, a t-butyl group, an isobutyl group, a pentyl group, an isopentyl group, a hexyl group, a heptyl group, a 2-ethylhexyl group, an octyl group, an isooctyl group, a nonyl group, an isononyl group, a decyl group, an isodecyl group, an undecyl group, a dodecyl group (lauryl group), a tridecyl group, a tetradecyl group, a stearyl group, and an octadecyl group.

Moreover, other monomers for forming the acrylic resins (monomers other than the acrylic or methacrylic acid esters having 30 or less carbon atoms) are not particularly restricted, and examples thereof include carboxyl group-containing monomers such as acrylic acid, methacrylic acid, carboxylethyl acrylate, carboxylpentyl acrylate, itaconic acid, maleic acid, fumaric acid, and crotonic acid; acid anhydride monomers such as maleic anhydride and itaconic anhydride; hydroxyl group-containing monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)-methyl acrylate; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl(meth)acrylate, and (meth)acryloyloxynaphthalenesulfonic acid; and phosphoric acid group-containing monomers such as 2-hydroxyethylacryloyl phosphate.

In the invention, the thermoplastic resin (particularly, an acrylic resin) can be used in a ratio of less than 90% by weight, for example, 1 to 90% by weight based on the whole amount of the polymer components including an epoxy resin. The ratio of the thermoplastic resin such as an acrylic resin is preferably 20% by weight to 85% by weight, and more preferably 40% by weight to 80% by weight based on the whole amount of the polymer components.

In order to perform the crosslinking in the die-adhering layer (particularly, adhesive layer composed of a resin composition containing an epoxy resin) in advance, a polyfunctional compound that reacts with a functional group in the end of molecular chain of the polymer is preferably added as a crosslinking agent at the production. Thereby, the adhesive characteristic under high temperature can be improved, and the improvement of the thermal resistance can be attained.

Other additives can be appropriately mixed in the die-adhering layer (adhesive layer composed of a resin composition containing an epoxy resin) according to needs. Examples of the other additives include flame retardants, silane coupling agents, and ion trapping agents as well as coloring agents, extenders, fillers, antiaging agents, antioxidants, surfactants, and crosslinking agents. Examples of the flame retardants include antimony trioxide, antimony pentoxide, and brominated epoxy resins. The flame retardants can be used solely or two or more types can be used in combination. Examples of the silane coupling agents include β-(3,4-epoxycyclohexyl)ethyltrimethoxysilane, γ-glycidoxypropyltrimethoxysilane, and γ-glycidoxypropylmethyldiethoxysilane. The silane coupling agents can be used solely or two or more kinds thereof can be used in combination. Examples of the ion trapping agents include hydrotalcites and bismuth hydroxide. The ion trapping agents can be used solely or two or more kinds thereof can be used in combination.

Incidentally, the die-adhering layer can be made to have an antistatic function. Thereby, the circuit can be prevented from breaking down due to the generation of electrostatic energy during adhesion and peeling thereof and charging of a workpiece (a semiconductor wafer, etc.) by the electrostatic energy. Imparting of the antistatic function can be performed by an appropriate method such as a method of adding an antistatic agent or a conductive substance to the base material, the gel-fraction highly changing pressure-sensitive adhesive layer, or the die-adhering layer or a method of providing a conductive layer composed of a charge-transfer complex, a metal film, or the like onto the base material. As these methods, a method that hardly generates an impurity ion having a fear of changing quality of the semiconductor wafer is preferable. Examples of the conductive substance (conductive filler) to be blended for the purpose of imparting conductivity, improving thermal conductivity, and the like include sphere-shaped, needle-shaped, flake-shaped powders of metals such as silver, aluminum, gold, copper, nickel, and a conductive alloy; metal oxides such as alumina; amorphous carbon black, and graphite. However, the die-adhering layer is preferably non-conductive from the viewpoint of no electric leakage.

The thickness of the die-adhering layer is not particularly restricted but is, for example, about 5 μm to 100 μm, and preferably about 5 μm to 50 μm.

Form of Pressure-Sensitive Adhesive Sheet Fitted with Die-Adhering Layer

The pressure-sensitive adhesive sheet fitted with the die-adhering layer according to the invention may have a form of a double-sided pressure-sensitive adhesive sheet wherein both surfaces are adhesive surfaces but preferably has a form of an adhesive sheet wherein only one surface is an adhesive surface. Therefore, the pressure-sensitive adhesive sheet fitted with the die-adhering layer is suitably a pressure-sensitive adhesive sheet fitted with the die-adhering layer having such a form that the die-adhering layer is laminated on the gel-fraction highly changing pressure-sensitive adhesive layer in the pressure-sensitive adhesive sheet having a constitution that the gel-fraction highly changing pressure-sensitive adhesive layer is formed on one surface of the base material.

Moreover, the pressure-sensitive adhesive sheet fitted with the die-adhering layer may be formed in a form that it is wound as a roll or may be formed in a form that the sheet is laminated. For example, in the case where the sheet has the form that it is wound as a roll, the sheet is wound as a roll in a state that the die-adhering layer is protected by a separator, that is, the sheet is wound as a roll in a state that the sheet is constituted by a base material, a gel-fraction highly changing pressure-sensitive adhesive layer formed on one surface of the base material, a die-adhering layer laminated on the gel-fraction highly changing pressure-sensitive adhesive layer, and a separator formed on the die-adhering layer, whereby the sheet can be prepared as a pressure-sensitive adhesive sheet fitted with the die-adhering layer in a state or form that it is wound as a roll. In this regard, the pressure-sensitive adhesive sheet fitted with the die-adhering layer in the state or form that it is wound as a roll may be constituted by a base material, a gel-fraction highly changing pressure-sensitive adhesive layer formed on one surface of the base material, a die-adhering layer laminated on the gel-fraction highly changing pressure-sensitive adhesive layer, and a releasably treated layer (rear surface treated layer) formed on the other surface of the base material.

As above, the pressure-sensitive adhesive sheet fitted with the die-adhering layer of the invention can have a form of a sheet-shape, a tape-shape, or the like.

### Separator

In the invention, as the separator (release liner), a commonly used release paper or the like can be used. The separator is used as a protective material of the die-adhering layer and is peeled off at the time when the pressure-sensitive adhesive sheet fitted with the die-adhering layer is pasted to the adherend. The separator is not necessarily provided. As the separator, for example, base materials having a release layer, such as plastic films and papers whose surface is treated with a releasing agent such as silicone-based one, long-chain alkyl-based one, fluorine-based one, or molybdenum sulfide; low adhesive base materials composed of fluorine-based polymers such as polytetrafluoroethylene, polychlorotrifluoroethylene, polyvinyl fluoride, polyvinylidene fluoride, tetrafluoroethylene-hexafluoropropylene copolymers, and chlorofluoroethylene-vinylidene fluoride copolymers; and low adhesive base materials composed of non-polar polymers such as olefinic resins (e.g., polyethylene, polypropylene, etc.) can be used. In this regard, it is also possible to utilize the separator as a base material for supporting the die-adhering layer (particularly, a supporting base material at the time when the die-adhering layer is transcribed onto the pressure-sensitive adhesive sheet for lamination).

Incidentally, the separator can be formed by known or commonly used methods. Moreover, the thickness of the separator is not particularly limited.

### Semiconductor Wafer

The semiconductor wafer is not particularly limited as long as it is a known or commonly used semiconductor wafer and can be appropriately selected from semiconductor wafers made of various materials and used. In the invention, as the semiconductor wafer, a silicon wafer can be suitably used.

### Producing Process of Semiconductor Device

The process for producing the semiconductor device of the invention is not particularly limited as long as it is a process for producing a semiconductor device using the above-described pressure-sensitive adhesive sheet fitted with the die-adhering layer. In the invention, a process for producing the semiconductor device including the following steps is suitable:

a step (mounting step) of attaching a semiconductor wafer to the die-adhering layer of the laminated film having the gel-fraction highly changing pressure-sensitive adhesive layer;

a step (dicing step) of subjecting the semiconductor wafer having the laminated film attached thereto to a cut-processing treatment after the mounting step;

a step (picking-up step) of peeling semiconductor chip(s) formed by the cut-processing treatment from the gel-fraction highly changing pressure-sensitive adhesive layer together with the die-adhering layer after the dicing step; and

a step (die-bonding step) of adhering the semiconductor chip fitted with the die-adhering layer to an adherend after the picking-up step.

Specifically, the semiconductor device can be produced using the pressure-sensitive adhesive sheet fitted with the die-adhering layer according to the invention after appropriate peeling of the separator arbitrarily provided on the die-adhering layer as follows. First, a semiconductor wafer is press-bonded and attached on the die-adhering layer in the pressure-sensitive adhesive sheet fitted with the die-adhering layer (i.e., the laminated film having the gel-fraction highly changing pressure-sensitive adhesive layer), and it is fixed by adhesion and holding (mounting step). The present step is performed while pressing with a pressing means such as a pressing roll.

Next, the dicing (cut-processing) of the semiconductor wafer is performed by subjecting the semiconductor wafer having the laminated film attached thereto to the cut-processing treatment (dicing step). Thereby, the semiconductor wafer is cut into a prescribed size and individualized (is formed into small pieces) to produce a semiconductor chip(s). The dicing is performed following a usual method from the circuit face side of the semiconductor wafer, for example. Moreover, in the present step, for example, there can be adopted a cutting method called full-cut that forms a slit into the pressure-sensitive adhesive sheet. The dicing apparatus used in the present step is not particularly restricted, and a conventionally known apparatus can be used. Furthermore, since the semiconductor wafer is adhered and fixed by the pressure-sensitive adhesive sheet fitted with the die-adhering layer, chip crack and chip fly can be suppressed, and at the same time, the damage of the semiconductor wafer can be also suppressed. In this regard, in the case where the die-adhering layer is formed of a resin composition containing an epoxy resin, even when it is cut by dicing, the generation of adhesive extrusion at the adhesive layer of the die-adhering layer is suppressed or prevented in the cut surface. As a result, re-attachment (blocking) of the cut surfaces each other can be suppressed or prevented and thus the picking-up to be mentioned below can be further conveniently performed.

In the case where the pressure-sensitive adhesive sheet fitted with the die-adhering layer is expanded, the expansion can be performed using a conventionally known expanding apparatus. The expanding apparatus has a doughnut-shaped outer ring capable of pushing the pressure-sensitive adhesive sheet fitted with the die-adhering layer downward through a dicing ring and an inner ring which has a diameter smaller than the outer ring and supports the pressure-sensitive adhesive sheet fitted with the die-adhering layer. By the expanding step, it is possible to prevent the damage of adjacent semiconductor chips through their contact with each other in the picking-up step to be mentioned below.

In order to recover a semiconductor chip that is adhered and fixed to the pressure-sensitive adhesive sheet fitted with the die-adhering layer, picking-up of the semiconductor chip is performed (picking-up step). Namely, the semiconductor chip formed by the cut-processing treatment is peeled from the gel-fraction highly changing pressure-sensitive adhesive layer together with the die-adhering layer to pick up the semiconductor chip. Here, in the picking-up, for changing the gel fraction of the gel-fraction highly changing pressure-sensitive adhesive layer to 90% by weight or more, the laminated film having the wafer mounted thereon is subjected to a heating treatment. The heating treatment can be performed by an appropriate method such as a method using a hot-air dryer, a method using a hot plate, or a method utilizing infrared ray irradiation. The temperature at the heating treatment may be a temperature capable of changing the gel fraction of the gel-fraction highly changing pressure-sensitive adhesive layer to 90% by weight or more (e.g., 100° C. or higher under normal pressure). By the heating treatment step, the gel fraction of the gel-fraction highly changing pressure-sensitive adhesive layer is increased to 90% by weight or more to decrease the close adhesion between the gel-fraction highly changing pressure-sensitive adhesive layer and the die-adhering layer, so that the semiconductor can be easily peeled off at the interface between the gel-fraction highly changing pressure-sensitive adhesive layer and the die-adhering layer of the pressure-sensitive adhesive sheet and thus it is possible to obtain the semiconductor chip fitted with the die-adhering layer without damage. As mentioned above, the picking-up of the semiconductor chip fitted with the die-adhering layer is performed at the time when the pressure-sensitive adhesive force between the die-adhering layer and the gel-fraction highly changing pressure-sensitive adhesive layer is sufficiently lowered. The method for the picking-up is not particularly limited and hitherto known methods can be adopted. For example, there may be mentioned a method of pushing up the individual semiconductor chips from the base material side of the pressure-sensitive adhesive sheet with a needle and picking up the pushed semiconductor chips with a picking-up apparatus. In the laminated film of the invention, since a good peeling ability between the die-adhering layer and the gel-fraction highly changing pressure-sensitive adhesive layer is achieved by the heating treatment, the picking-up can be performed with reducing a yield ratio by lowering a protrusion degree of the needle or decreasing the number of the needles.

The semiconductor chip (semiconductor chip fitted with the die-adhering layer) picked up is adhered and fixed to an adherend through the die-adhering layer interposed therebetween (die bonding step). The adherend has been mounted on a heat block. Examples of the adherend include a lead frame, a TAB film, a substrate, and a semiconductor chip separately produced. The adherend may be a deformable adherend that is easily deformed, or may be a non-deformable adherend (such as a semiconductor wafer) that is difficult to deform, for example.

A conventionally known substrate can be used as the substrate. Moreover, a metal lead frame such as a Cu lead frame or a 42 Alloy lead frame and an organic substrate composed of glass epoxy, BT (bismaleimide-triazine), or a polyimide can be used as the lead frame. However, the invention is not restricted to the above, and includes a circuit substrate that can be used after mounting a semiconductor element and electrically connecting with the semiconductor element.

In the case where the die-adhering layer is formed of a resin composition containing a thermosetting resin such as an epoxy resin, the adhesive force is enhanced by heat-curing and thus the semiconductor chip can be adhered and fixed onto the adherend through the die-adhering layer interposed therebetween to improve the degree of the heat resistance. In this regard, a product in which the semiconductor chip is adhered and fixed onto a substrate or the like through a semiconductor wafer-pasting part interposed therebetween can be subjected to a reflow step. Thereafter, wire bonding is performed by electrically connecting the tip of a terminal part (inner lead) of the substrate and an electrode pad on the semiconductor chip with a bonding wire, and furthermore, the semiconductor chip is sealed with a sealing resin, followed by subjecting the sealing resin to after-curing. Thereby, the semiconductor device according to the present embodiment is manufactured.

### Examples

The following will illustratively describe preferred examples of the invention in detail. However, the materials, the mixing amount, and the like described in these examples are not intended to limit the scope of the invention to only those unless otherwise stated, and they are merely explanatory examples. Moreover, part in each example is a weight standard unless otherwise stated.

### Example 1

### (Manufacture of Pressure-Sensitive Adhesive Sheet)

An acrylic polymer was obtained by charging 96.8 parts by weight of 2-ethylhexyl acrylate (sometimes refers to as “2EHA”), 3.2 parts by weight of 2-hydroxyethyl acrylate (sometimes refers to as “HEA”), 0.2 part by weight of benzoyl peroxide, and 65 parts by weight of toluene into a reactor equipped with a condenser, a nitrogen-introducing pipe, a stirring apparatus, and a thermometer, and carrying out a polymerization reaction at 61° C. for 6 hours under a nitrogen atmosphere.

Next, a pressure-sensitive adhesive solution was prepared by adding 3.0 parts by weight of an isocyanate-based crosslinking agent (product name “COLONATE L” manufactured by Nippon Polyurethane Industry Co., Ltd.) and 4.0 parts by weight of a blocked isocyanate (product name “Takenate WB-700” manufactured by Mitsui Chemical Polyurethane Industries, Ltd.; blocking agent dissociation temperature: 120° C.) to 100 parts by weight of the acrylic polymer.

The above-described pressure-sensitive adhesive solution was applied on the releasably treated surface of a polyethylene terephthalate film whose one surface had been releasably treated (release liner) and was dried at 100° C. for 2 minutes to form a pressure-sensitive adhesive layer having a thickness of 10 μm. Then, a polyolefin film (base material; thickness: 100 μm) was pasted on the surface of the pressure-sensitive adhesive layer to obtain a pressure-sensitive adhesive sheet according to the invention. Thereafter, the sheet was stored at 50° C. for 48 hours.

### (Manufacture of Die-Adhering Layer and Laminated Film)

59 parts by weight of an epoxy resin 1 (product name “EPICOAT 1004” manufactured by Japan Epoxy Resins (JER) Co., Ltd.), 53 parts by weight of an epoxy resin 2 (product name “EPICOAT 827” manufactured by Japan Epoxy Resins (JER) Co., Ltd.), 121 parts by weight of a phenol resin (product name “MILEX XLC-4L” manufactured by Mitsui Chemicals, Inc.), 222 parts by weight of spherical silica (product name “SO-25R” manufactured by Admatechs Co., Ltd.) based on 100 parts by weight of an acrylic acid ester-based polymer (product name “PARACRON W-197CM” manufactured by Negami Chemical Industrial Co., Ltd.) containing ethyl acrylate-methyl methacrylate as a main component were dissolved into methyl ethyl ketone to prepare a solution of an adhesive composition having a solid concentration of 23.6% by weight.

The solution of the adhesive composition was applied onto a polyethylene terephthalate film on which a release treatment had been performed, thereby a die-adhering layer sheet having a thickness of 25 μm being obtained. The release liner of the above-described pressure-sensitive adhesive sheet was peeled off and the above-described die-adhering layer was transcribed onto the pressure-sensitive adhesive layer (gel-fraction highly changing pressure-sensitive adhesive layer) to obtain a pressure-sensitive adhesive layer fitted with a die-adhering layer according to the present Example.

### Examples 2 to 5

Pressure-sensitive adhesive sheets fitted with a die-adhering layer (laminated films) were manufactured in the same manner as in Example 1 except that the composition of the pressure-sensitive adhesive composition was changed to the composition (kind and content of monomer components) shown in Table 1.

### Comparative Examples 1 to 3

Pressure-sensitive adhesive sheets fitted with a die-adhering layer (laminated films) were manufactured in the same manner as in Example 1 except that the composition of the pressure-sensitive adhesive composition was changed to the composition (kind and content of monomer components) shown in Table 1.

### Comparative Example 4

A pressure-sensitive adhesive sheet fitted with a die-adhering layer (laminated film) was manufactured in the same manner as in Example 1 except that 5 parts by weight of a photocurable oligomer (product name “KAYARAD DPHA” manufactured by Nippon Kayaku Co., Ltd.) was used instead of the thermal crosslinking agent.

### Comparative Example 5

A pressure-sensitive adhesive sheet fitted with a die-adhering layer (laminated film) was manufactured in the same manner as in Example 1 except that 40 parts by weight of a heat-expandable microsphere (product name “MICROSPHERE F-50” manufactured by Matsumoto Yushi-Seiyaku Co., Ltd.) was used instead of the thermal crosslinking agent.

TABLE 1

| | Gel fraction | | | | | | Thermal |
|---|---|---|---|---|---|---|---|
| | (% by weight) | | Composition | | | Crosslinking | crosslinking |
| | Before | After | [% by weight (mol %)] | | | agent (part | agent (part |
| | heating | heating | 2EHA | BA | HEA | by weight) | by weight) |
| Example 1 | 85 | 95 | 96.8 (95) | | 3.2 (5) | 3 | 4 |
| Example 2 | 70 | 97 | 96.8 (95) | | 3.2 (5) | 2 | 5 |
| Example 3 | 50 | 92 | 96.8 (95) | | 3.2 (5) | 1 | 6 |
| Example 4 | 85 | 95 | 64.0 (55) | 32.4 (40) | 3.6 (5) | 3 | 4 |
| Example 5 | 80 | 93 | 38.3 (30) | 57.7 (65) | 4.0 (5) | 3 | 4 |
| Comparative | 50 | 50 | 96.8 (95) | | 3.2 (5) | 1 | |
| Example 1 | | | | | | | |
| Comparative | 93 | 97 | 96.8 (95) | | 3.2 (5) | 4 | 3 |
| Example 2 | | | | | | | |
| Comparative | 50 | 65 | 96.8 (95) | | 3.2 (5) | 1 | 1 |
| Example 3 | | | | | | | |
| Comparative | 85 | 95 | 96.8 (95) | | 3.2 (5) | 3 | UV |
| Example 4 | (before UV) | (after UV) | | | | | oligomer: 5 |
| Comparative | 85 | 85 | 96.8 (95) | | 3.2 (5) | 3 | Foaming |
| Example 5 | | | | | | | agent: 40 |

Incidentally, meanings of the abbreviations described in Table 1 are as follows. 2EHA: 2-ethylhexyl acrylate

BA: n-butyl acrylate

HEA: 2-hydroxyethyl acrylate

Moreover, in the columns of Composition in Table 1, the unit of the values in the upper column is % by weight based on the whole amount of monomer components and the unit of the values in parenthesis in the lower column is mol % (% by mol) based on the whole amount of monomer components.

TABLE 2

| | Pressure-sensitive | | | | | | |
|---|---|---|---|---|---|---|---|
| | adhesive force (N/10 mm) | | | Picking-up | Fouling | Pressure-sensitive | |
| | Before | After | Chip | success | preventive | adhesive force after | Storage |
| | heating | heating | fly | rate (%) | property | storage (N/10 mm) | ability |
| Example 1 | 3.50 | 1.10 | Good | 100 | Good | 3.50 | Good |
| Example 2 | 4.30 | 1.05 | Good | 100 | Good | 4.31 | Good |
| Example 3 | 4.70 | 1.35 | Good | 100 | Good | 4.73 | Good |
| Example 4 | 4.50 | 1.50 | Good | 100 | Good | 4.50 | Good |
| Example 5 | 4.65 | 2.60 | Good | 91 | Good | 4.60 | Good |
| Comparative | 4.72 | 5.00 | Good | 0 | Bad | 4.70 | Good |
| Example 1 | | | | | | | |
| Comparative | 1.35 | 1.07 | Bad | 100 | Good | 1.35 | Good |
| Example 2 | | | | | | | |
| Comparative | 4.60 | 3.50 | Good | 0 | Bad | 4.63 | Good |
| Example 3 | | | | | | | |
| Comparative | 3.30 | 2.50 | Good | 0 | Good | 1.30 | Bad |
| Example 4 | | | | | | | |
| Comparative | 3.25 | 0.00 | Good | 100 | Bad | 3.30 | Good |
| Example 5 | | | | | | | |

### (Evaluation)

With regard to each of the pressure-sensitive adhesive sheets fitted with a die-adhering layer (laminated films) manufactured in Examples 1 to 5 and Comparative Examples 1 to 5, a gel fraction of the pressure-sensitive adhesive layer before heating, a gel fraction of the pressure-sensitive adhesive layer after heating, pressure-sensitive adhesive force before heating, and pressure-sensitive adhesive force before heating were measured by the following measurement method and also a chip fly preventive property, a picking-up property, a fouling preventive property, and storage stability were evaluated by the following evaluation methods. The results were shown in Table 2.

(Measurement Method of Gel Fraction before Heating)

About 0.1 g was sampled from the pressure-sensitive adhesive layer (pressure-sensitive adhesive layer before the heating treatment) of the pressure-sensitive adhesive sheet in each of the pressure-sensitive adhesive sheets fitted with a die-adhering layer and was precisely weighed (Sample Weight). After wrapped with a mesh sheet (manufactured with Teflon (registered trade mark)), the sample was immersed in about 50 ml of toluene at room temperature for 1 week. Thereafter, a solvent-insoluble content (a content in the mesh sheet) was taken out of the toluene and dried at 130° C. for about 2 hours after placed in a dryer, the solvent-insoluble content was weighed after drying (Weight after Immersion and Drying), and a gel fraction (% by weight) was calculated according to the following equation (a). Incidentally, the measurement results of the gel fraction (gel fraction before heating) are shown in the column of “Before heating” in “Gel fraction (% by weight)” in Table 1.

Gel Fraction (% by weight)=[(Weight after Immersion and Drying)/(Sample Weight)]×100 (a)

### (Measurement Method of Gel Fraction After Heating)

The pressure-sensitive adhesive sheet in each of the pressure-sensitive adhesive sheets fitted with a die-adhering layer was subjected to a heating treatment at 130° C. for 3 minutes in a hot-air dryer and thereafter, only the pressure-sensitive adhesive layer was separated. Incidentally, with regard to Comparative Example 4, instead of the heating treatment, UV irradiation was performed under a condition of an integrated light intensity of 300 mJ/cm² using a UV irradiation apparatus (product name “UM-810” manufactured by Nitto Seiki Co., Ltd.). About 0.1 g was sampled from the pressure-sensitive adhesive layer (pressure-sensitive adhesive layer after the heating treatment) and was precisely weighed (Sample Weight). After wrapped with a mesh sheet (manufactured with Teflon (registered trade mark)), the sample was immersed in about 50 ml of toluene at room temperature for 1 week. Thereafter, a solvent-insoluble content (a content in the mesh sheet) was taken out of the toluene and dried at 130° C. for about 2 hours after placed in a dryer, the solvent-insoluble content was weighed after drying (Weight after Immersion and Drying), and a gel fraction (% by weight) was calculated according to the following equation (a). Incidentally, the measured results of the gel fraction (gel fraction after heating) are shown in the column of “After heating” in “Gel fraction (% by weight)” in Table 1.

Gel Fraction (% by weight)=[(Weight after Immersion and Drying)/(Sample Weight)]×100 (a)

### (Measurement Method of Pressure-Sensitive Adhesive Force Before Heating)

Each of the pressure-sensitive adhesive sheets fitted with a die-adhering layer (each of the pressure-sensitive adhesive sheets fitted with a die-adhering layer before 2 0 heating) was cut into a size having a width of 10 mm and a length of 10 cm and, after the separator was peeled off, the exposed surface of the die-adhering layer and a semiconductor wafer having a thickness of 0.6 mm were press-bonded at a temperature of 40° C. by a heat lamination method. After the press-bonding, the sheet was allowed to stand at a temperature of 23° C. for 30 minutes. After standing, the pressure-sensitive adhesive sheet was peeled off under conditions of a temperature of 23° C. and a humidity of 60% RH under conditions of a peeling rate (drawing rate) of 300 mm/min and a peeling angle of 15° using a tensile testing machine (product name “Autograph AG-IS” manufactured by Shimadzu Corporation) and a maximum load at the peeling (a maximum value of the load excluding a peak top at the initial stage of the measurement) was determined, the maximum load being regarded as peeling pressure-sensitive adhesive force between the pressure-sensitive adhesive layer and the die-adhering layer to determine pressure-sensitive adhesive force (N/10 mm width) of the pressure-sensitive adhesive layer of the pressure-sensitive adhesive sheet. The measured results of the pressure-sensitive adhesive force are shown in the column of “Before heating” in “Pressure-sensitive adhesive force (N/10 mm)” in Table 2.

### (Measurement Method of Pressure-Sensitive Adhesive Force After Heating)

Each of the pressure-sensitive adhesive sheets fitted with a die-adhering layer was cut into a size having a width of 10 mm and a length of 10 cm and, after the separator was peeled off, the exposed surface of the die-adhering layer and a semiconductor wafer having a thickness of 0.6 mm were press-bonded at a temperature of 40° C. by a heat lamination method. After the press-bonding, the sheet was allowed to stand at a temperature of 23° C. for 30 minutes. Then, it was subjected to a heating treatment at a temperature of 120° C. for 3 minutes in a hot-air drier. Incidentally, with regard to Comparative Example 4, instead of the heating treatment, UV irradiation was performed under a condition of an integrated light intensity of 300 mJ/cm² using a UV irradiation apparatus (product name “UM-810” manufactured by Nitto Seiki Co., Ltd.). After the heating treatment, the pressure-sensitive adhesive sheet was peeled off under conditions of a temperature of 23° C. and a humidity of 60% RH under conditions of a peeling rate (drawing rate) of 300 mm/min and a peeling angle of 15° using a tensile testing machine (product name “Autograph AG-IS” manufactured by Shimadzu Corporation) and a maximum load at the peeling (a maximum value of the load excluding a peak top at the initial stage of the measurement) was determined, the maximum load being regarded as the peeling pressure-sensitive adhesive force between the pressure-sensitive adhesive layer and the die-adhering layer to determine pressure-sensitive adhesive force (N/10 mm width) of the pressure-sensitive adhesive layer of the pressure-sensitive adhesive sheet. The measured results of the pressure-sensitive adhesive force are shown in the column of “After heating” in “Pressure-sensitive adhesive force (N/10 mm)” in Table 2.

### (Evaluation Method of Chip-Fly Preventive Property)

Each of the pressure-sensitive adhesive sheets fitted with a die-adhering layer (laminated films) and a semiconductor wafer having a thickness of 0.075 mm and a diameter of 8 inch were press-bonded at a temperature of 40° C. by a heat lamination method and further the semiconductor wafer was diced into a chip of 10 mm square by means of a rotary round blade. In this regard, the dicing conditions are as shown below. With regard to the semiconductor wafer subjected to the cutting step, the generation of chip fly was visually confirmed and the chip-fly preventive property was evaluated according to the following evaluation standard. The evaluation of the chip-fly preventive property was used as a substitute evaluation of the wafer fixing and holding property of the laminated film. Therefore, smaller chip fly shows better wafer fixing and holding property of the laminated film. In this regard, the evaluation results of the chip-fly preventive property are shown in the column of “Chip fly” in Table 2.

### (Evaluation Standard of Chip-Fly Preventive Property)

Good (absence of chip fly): even one piece of peeled chip is not present among the cut chips

Bad (presence of chip fly): at least one piece of peeled chip is present among the cut chips.

### (Dicing Conditions)

Dicing apparatus: product name “DFD-6361” manufactured by DISCO Corporation
Dicing ring: “2-8-1” (manufactured by DISCO Corporation)
Dicing speed: 80 mm/sec
Dicing Blade:

Z1; “2050HEDD” (manufactured by DISCO Corporation)

Z2; “2050HEBB” (manufactured by DISCO Corporation)

### Dicing Blade Rotation Speed:

Z1; 40,000 rpm

Z2; 40,000 rpm

### Blade Height:

Z1; 0.170 mm

Z2; 0.085 mm

### Cutting Method: A Mode/Step Cutting

### Wafer Chip Size: 10.0 mm Square

### (Evaluation Method of Picking-Up Property)

A semiconductor wafer having a thickness of 0.075 mm and a diameter of 8 inch was press-bonded on the die-adhering layer of each of the pressure-sensitive adhesive sheets fitted with a die-adhering layer (laminated films) at a temperature of 40° C. by a thermal lamination method, and further the semiconductor wafer was diced into a chip of 10 mm square by means of a rotary round blade. The dicing conditions are as shown below. Then, the semiconductor chips obtained by cutting (dicing) were subjected to a heating treatment at 120° C. for 3 minutes together with the laminated film in a hot-air dryer. Incidentally, with regard to Comparative Example 4, UV irradiation was performed under a condition of an integrated light intensity of 300 mJ/cm² using a UV irradiation apparatus (product name “UM-810” manufactured by Nitto Seiki Co., Ltd.).

After the heating treatment, 400 pieces of the semiconductor chips were picked up under the following picking-up conditions and the success rate of picking-up (%; success rate) was calculated to evaluate a picking-up property. The evaluation results of the picking-up property are shown as a success rate (%) in the column of “picking-up success rate (%)” in Table 2. Therefore, the picking-up property becomes better as the success rate increases.

### (Dicing Conditions)

Dicing apparatus: product name “DFD-6361” manufactured by DISCO Corporation
Dicing ring: “2-8-1” (manufactured by DISCO Corporation)
Dicing speed: 80 mm/sec
Dicing blade:

Z1; “2050HEDD” (manufactured by DISCO Corporation)

Z2; “2050HEBB” (manufactured by DISCO Corporation)

### Dicing Blade Rotation Speed:

Z1; 40,000 rpm

Z2; 40,000 rpm

### Blade Height:

Z1; 0.170 mm

Z2; 0.085 mm

Cutting method: A mode/step cutting
Wafer chip size: 10.0 mm square

### (Picking-Up Conditions)

Used needle: total length 10 mm, diameter 0.7 mm, acute angle 15 deg, end R 350 pm
Number of needles: 9 needles
Needle pushing-up amount: 200 μm
Needle pushing-up rate: 5 mm/sec
Collet holding time: 200 msec
Expanding: 3 mm

### (Evaluation Method of Fouling Preventive Property)

With regard to each of the pressure-sensitive adhesive sheets with a die-adhering layer, the pressure-sensitive adhesive sheet before pasted to the die-adhering layer was press-bonded to a semiconductor wafer having a diameter of 8 inch using a roller of a 2 kg load. After the press-bonding, the sheet was allowed to stand at a temperature of 23° C. for 1 hour and after standing, was subjected to a heating treatment at a temperature of 120° C. for 3 minutes using a hot-air dryer. Incidentally, with regard to Comparative Example 4, UV irradiation was performed under a condition of an integrated light intensity of 300 mJ/cm² using a UV irradiation apparatus (product name “UM-810” manufactured by Nitto Seiki Co., Ltd.). After the heating treatment, the pressure-sensitive adhesive sheet was peeled from the semiconductor wafer under conditions of a temperature of 23° C. and a humidity of 60% RH under conditions of a drawing rate of 300 mm/min and a peeling angle of 180°. The surface of the semiconductor wafer after the peeling of the pressure-sensitive adhesive sheet was visually observed and the fouling preventive property was evaluated according to the following evaluation standard. This method was used as a substitute evaluation of the fouling protective property. In this regard, the evaluation results of the fouling preventive property are shown in the column of “Fouling preventive property” in Table 2.

### (Evaluation Standard of Fouling Preventive Property)

Good (absence of fouling): no transcription (remaining) of the pressure-sensitive adhesive was visually confirmed on the semiconductor wafer surface after peeling of the pressure-sensitive adhesive sheet.

Bad (presence of fouling): transcription (remaining) of the pressure-sensitive adhesive was visually confirmed on the semiconductor wafer surface after peeling of the pressure-sensitive adhesive sheet.

### (Evaluation Method of Storage Stability)

Each of the pressure-sensitive adhesive sheets fitted with a die-adhering layer (laminated films) was stored at a temperature of 23° C. at a humidity of 60% RH under a fluorescent lamp (illuminance 300 lux) for 1 week. Pressure-sensitive adhesive force (pressure-sensitive adhesive force of the pressure-sensitive adhesive layer before heating) was measured on the laminated film after 1 week by the same method as mentioned above and the storage stability was evaluated according to the following standard. In this regard, the evaluation results of the storage stability are shown in the column of “Pressure-sensitive adhesive force after storage (N/10 mm)” and “Storage ability” in Table 2.

### (Evaluation Standard of Storage Stability)

Good: the value of the pressure-sensitive adhesive force after the storage under the fluorescent light (pressure-sensitive adhesive force (N/10 mm) of the pressure-sensitive adhesive layer after storage) is not changed by 10% or more as compared with the value before the storage under the fluorescent light.

Bad: the value of the pressure-sensitive adhesive force after the storage under the fluorescent light (pressure-sensitive adhesive force (N/10 mm) of the pressure-sensitive adhesive layer after storage) is changed by 10% or more as compared with the value before the storage under the fluorescent light.

From Tables 1 and 2, it has been confirmed that the pressure-sensitive adhesive sheets fitted with a die-adhering layer (laminated films) according to Examples 1 to 5 are excellent in all of the chip-fly preventive property, the picking-up property, the fouling preventive property, and storage stability and satisfy the characteristics required in the semiconductor wafer processing steps. Namely, it has been confirmed that the semiconductor wafer can be subjected to a cut-processing with an excellent dicing property and also the adherend (cut-processed chip) can be easily peeled off without occurrence of fouling by heating when the pressure-sensitive adhesive sheets fitted with a die-adhering layer (laminated films) according to Examples 1 to 5 are used. Furthermore, the pressure-sensitive adhesive sheets fitted with a die-adhering layer exhibit good storage stability.

On the other hand, the laminated film according to Comparative Example 1 does not contain a thermal crosslinking agent and cannot satisfy the required characteristics of the picking-up success rate and the fouling preventive property. The laminated film according to Comparative Example 2 has a high gel fraction before heating and chip fly occurred. The laminated film according to Comparative Example 3 has a low gel fraction after heating and does not satisfy the picking-up property and the fouling preventive property. The laminated film according to Comparative Example 4 does not undergo curing through crosslinking of the pressure-sensitive adhesive layer induced by a thermal crosslinking agent but has a curing mechanism induced by UV irradiation. The laminated film according to Comparative Example 4 cannot satisfy both characteristics of the picking-up success rate and the storage stability. The laminated film according to Comparative Example 5 has a pressure-sensitive adhesive layer having a heat-expandable microcapsule instead of a thermal crosslinking agent and the fouling of the die-adhering layer with the pressure-sensitive adhesive is confirmed, so that the laminated film cannot satisfy the characteristic of the fouling preventive property.

The laminated film of the invention can be suitably used as a pressure-sensitive adhesive sheet fitted with a die-adhering layer for use in the production of semiconductor devices such as semiconductor chips. A semiconductor wafer can be effectively cut-processed by the use of the laminated film of the invention and also, after the cut-processing, the film can be easily peeled off with suppressing or preventing occurrence of fouling. Accordingly, it becomes possible to produce semiconductor devices and thus electronic parts and the like with ease and with an excellent productivity.

While the present invention has been described in detail and with reference to specific embodiments thereof, it will be apparent to one skilled in the art that various changes and modifications can be made therein without departing from the scope thereof.

This application is based on Japanese patent application No. 2009-110575 filed Apr. 30, 2009, the entire contents thereof being hereby incorporated by reference.

What is claimed is:

1. A laminated film which comprises a pressure-sensitive adhesive sheet comprising a pressure-sensitive adhesive layer, and a die-adhering layer laminated on the pressure-sensitive adhesive layer of the pressure-sensitive adhesive sheet,
wherein the pressure-sensitive adhesive layer of the pressure-sensitive adhesive sheet is formed of a pressure-sensitive adhesive composition containing a base polymer and a thermal crosslinking agent, and the pressure-sensitive adhesive layer is such that the gel fraction thereof before heating is less than 90% by weight and the gel fraction thereof after heating is changed to 90% by weight or more.

2. The laminated film according to claim 1, wherein the thermal crosslinking agent contained in the pressure-sensitive adhesive composition for forming the pressure-sensitive adhesive layer of the pressure-sensitive adhesive sheet is a thermal crosslinking agent in which crosslinking-reactive functional groups are inactivated before heating and at least two crosslinking-reactive functional groups in one molecule are capable of being activated by heating.

3. The laminated film according to claim 1, wherein the thermal crosslinking agent is a blocked isocyanate.

4. The laminated film according to claim 1, wherein the base polymer contained in the pressure-sensitive adhesive composition for forming the pressure-sensitive adhesive layer of the pressure-sensitive adhesive sheet is an acrylic polymer composed of an acrylic acid alkyl ester represented by CH₂═CHCOOR (where R is an alkyl group having 6 to 10 carbon atoms) as a main monomer component, and the ratio of the acrylic acid alkyl ester represented by the above formula is 50 to 99% by mol based on the total amount of monomer components.

5. The laminated film according to claim 1, wherein the pressure-sensitive adhesive layer has a pressure-sensitive adhesive force (peeling angle: 15°, drawing rate: 300 mm/min) at 23° C. of 1 N/10 mm width to 10 N/10 mm width when the laminated film is press-bonded (pressure: 1.47×10⁵ Pa, time: 1 minute) to a semiconductor wafer having a thickness of 0.6 mm by a heat lamination method at 40° C. in such a form that the die-adhering layer comes into contact with a surface of the semiconductor wafer and subsequently allowed to stand under an atmosphere of 23° C. for 30 minutes, and
the pressure-sensitive adhesive layer has a pressure-sensitive adhesive force (peeling angle: 15°, drawing rate: 300 mm/min) at 23° C. of 5 N/10 mm width or less when the laminated film is press-bonded (pressure: 1.47×10⁵ Pa, time: 1 minute) to a semiconductor wafer having a thickness of 0.6 mm by a heat lamination method at 40° C. in such a form that the die-adhering layer comes into contact with a surface of the semiconductor wafer, subsequently allowed to stand under an atmosphere of 120° C. for 3 minutes, and thereafter allowed to stand under an atmosphere of 23° C. for 30 minutes.

6. A process for producing a semiconductor device, in which a laminated film which comprises a pressure-sensitive adhesive sheet comprising a pressure-sensitive adhesive layer, and a die-adhering layer laminated on the pressure-sensitive adhesive layer of the pressure-sensitive adhesive sheet is used, the process comprises steps of:
attaching a semiconductor wafer to the die-adhering layer of the laminated film according to claim 1,
subjecting the semiconductor wafer having the laminated film attached thereto to a cut-processing treatment,
peeling semiconductor chips formed by the cut-processing treatment from the pressure-sensitive adhesive layer together with the die-adhering layer, and
adhering the semiconductor chip fitted with the die-adhering layer to an adherend.
